(19) United States
(12) Patent Application Publication
(10) Pub. No.: US 2020/0017750 A1
(43) Pub. Date: Jan. 16, 2020

(54) Fluids For Fracking Of Paraffinic Oil Bearing Formations

(71) Applicant: Clariant International Ltd., Muttenz (CH)

(72) Inventors: Amir MAHMOUDKHANI, The Woodlands, TX (US); Matthias KRULL, Harxheim (DE); Michael FEUSTEL, Köngernheim (DE)

(73) Assignee: Clariant International Ltd., Muttenz (CH)

(21) Appl. No.: 16/495,375

(22) PCT Filed: Jan. 16, 2018
(86) PCT No.: PCT/EP2018/050915

§ 371 Date: Sep. 18, 2019

(30) Foreign Application Priority Data
Mar. 30, 2017 (US) 15474830
Apr. 19, 2017 (EP) 17166968.2

(51) Int. Cl. C09K 8/524; C09K 8/68; C09K 8/80; C09K 8/60; C09K 8/575; E21B 43/26

(52) U.S. Cl. CPC C09K 8/524; C09K 8/68; C09K 8/685; C09K 8/805; C09K 2208/32; C09K 8/5753; C09K 8/5755; E21B 43/26; C09K 2208/28; C09K 8/602

(57) ABSTRACT

This invention provides a fracturing fluid comprising
i) 85 wt.-% or more of an aqueous carrier fluid as continuous phase,
ii) 0.001 to 1.5 wt.-% of a first wax inhibitor being dispersed in the carrier fluid, the wax inhibitor being selected from the group consisting of
   a) copolymers of ethylene and ethylenically unsaturated esters, ethers and/or C₃ to C₃₀-alkenes,
   b) homo- or copolymers of ethylenically unsaturated carboxylic acids, bearing C₁₂-C₅₀-alkyl radicals bound via ester, amide and/or imide groups,
   c) ethylene copolymers grafted with ethylenically unsaturated esters and/or ethers,
   d) homo- and copolymers of C₃ to C₃₀-olefins, and
   e) condensation products of alkyl phenols with aldehydes and/or ketones
iv) optionally a water soluble polymer for viscosity adjustment,
   wherein the amount of water-immiscible hydrocarbons is less than 2.5 wt.-%.

The present invention relates generally to the field of hydrocarbon production from hydrocarbon-bearing formations. More particularly, it concerns fluid compositions that can be useful in fracturing stimulation of hydrocarbon bearing formations, their manufacture and methods of inhibiting wax deposition during hydraulic fracturing treatments of hydrocarbon bearing formations.

Hydrocarbons (crude oil, natural gas, etc.) are usually obtained from subterranean geologic formations (e.g., a “reservoir”) by drilling a well that penetrates the hydrocarbon-bearing formation. This provides a partial flow path for the oil to reach the surface. In order for oil to be “produced”, that is to travel from the formation to the well bore (and ultimately to the surface), there must be a sufficiently unimpeded flow path within the formation towards the well bore. Unobstructed flow through the formation rock (e.g., sandstone, carbonates) is possible when rock pores of sufficient size and number are present for the oil to move through the formation.

Techniques used to increase the permeability of the formation are referred to as “stimulation”. Hydraulic fracturing has become an important stimulation technique to enhance production of hydrocarbon fluids from oil and gas bearing formations. The fracturing process involves injecting a fluid at a pressure sufficiently high to break down the rock, thereby creating one or more channels through which hydrocarbons can more readily flow from the formation and into the well bore. Proppant slurries are then pumped into the induced fracture to keep it from closing once the pumping operation is completed so that the hydrocarbon production from the well can be significantly enhanced.

Fracturing treatments essentially comprise two principal components: a carrier fluid (usually water or brine), and a proppant. Chemical additives used in carrier fluids include but are not limited to friction reducers, scale inhibitors, surfactants and biocides. Gelling agents such as biopolymers, synthetic polymers and/or viscoelastic surfactants may be used to increase the viscosity of the fracturing fluid which aids in the creation of a fracture; and to thicken the aqueous solution so that solid particles of proppant can be stably suspended in the carrier fluid for delivery into the fracture. Most often fracturing treatments start with pumping of carrier liquid (“prepad”, “pad”) into the well, i. a. to fill the casing and tubing and to break down the formation. Afterwards propping agent is added to the carrier fluid in order to keep the fracture open.

Usually the proppant is a solid material, most often sand, treated sand or man-made ceramic materials, designed to keep an induced hydraulic fracture open, during and/or following a fracturing treatment. There have been various attempts to improve the properties of such proppants, e. g. their mechanical stability, sedimentation behaviour and rheological behaviour. For example, U.S. Pat. No. 8,133,587 provides thermoplastic coated proppants comprising a thermoplastic material including an ethylene vinyl acetate copolymer and/or a phenol-formaldehyde novolac resin. With the temperature in the formation being above the thermal transition point temperature of the thermoplastic coating it becomes tacky, thereby agglomerating the thermoplastic coating of the coated proppants to form a stable framework of proppant particles.

Crude oils are complex mixtures of different types of substances, some of which can present problems during production, transport, storage and/or further processing. In the reservoir crude oils exist in a state of chemical and physical equilibrium of its components and with other fluids. Fracturing and subsequent production of oil induce a pressure and temperature drop in the reservoir. Due to lower temperature and/or volatilization of the lighter hydrocarbons which act as solvents for i. a. paraffins and asphaltenes under reservoir conditions the solvency of the matrix changes. As a result, especially heavy paraffins and/or asphaltenes become less soluble in the remaining fluid and tend to precipitate during fracturing, production, transport and/or storage of the crude oil. At lower temperatures, usually below the pour point of the crude, this often causes flow problems by gelling of the waxy fluid.

Flow problems caused by gelling of paraffins can be reduced in a number of ways, including heating the formation and/or lines, diluting the oil with solvent or using special additives which interfere with wax crystal formation and growth. The so-called pour point depressants improve the cold flowability and prevent gelling of the oils, for example by modifying the crystal structure of the paraffins during precipitation upon cooling. Said inhibitors are predominantly synthetic polymeric compounds, for example ethylene-vinyl acetate copolymers, poly(alkyl (meth)acrylates), esterified and/or amidated/imidized maleic acid-olefin-copolymers and alkyl phenol-aldehyde resins. Asphaltene dispersants act primarily by preventing the asphaltenes from agglomeration. Typical asphaltene dispersants are oil soluble amphiphilic dispersants.

The customary polymeric pour point depressants are typically oil soluble and are applied to the crude oil as a solution in organic, predominantly aromatic solvents. However, also dispersions of pour point depressants in water and/or other polar solvents with poor solubility for the pour point depressant have been proposed. Both dosage forms are predominantly applied in topside treatments after the produced oil has left the well.

Dispersions of pour point depressants distinguish themselves from solutions in organic solvents by lower pour points though having the same or even higher active contents. One approach to such dispersions is their preparation by emulsion polymerization, which is said to lead to more readily manageable additives.

For instance, WO-03/014170 discloses pour point depressants prepared by emulsion copolymerization of alkyl (meth)acrylates with water-soluble and/or polar comonomers. These are prepared, for example, in dipropylene glycol monomethyl ether or in water/Dowanol with alkylbenzylammonium chloride and a fatty alcohol alkoxide as emulsifiers and contain 5 to 70 wt.-% polymer.

EP-A-0 359 061 discloses aqueous emulsion polymers of long-chain alkyl (meth)acrylates with acidic comonomers for the improvement of the flow properties of hydrocarbon mixtures. The dispersions contain approximately 20 to 70 wt.-% of polymer.

U.S. Pat. No. 3,722,592 teaches a method for inhibiting the deposition of paraffin in liquid oil either in the oil well, gas wells, etc., or on the earth's surface by utilizing a stable aqueous emulsion of polyethylene wherein the polyethylene is branched at least in part and has a molecular weight in excess of 6,000, the emulsifier being selected from the group consisting of anionic, nonionic, and cationic emulsifiers.

U.S. Pat. No. 3,096,777 teaches a method of inhibiting the adhesion of solid hydrocarbonaceous material deposited from oil containing such substances in solution and suspension on a deposition-susceptible surface of equipment with which such oil comes in contact which comprises subjecting the surface thus contacted to the action of an aqueous dispersion containing at least about 0.0025 percent of a water-dispersible hydrophilic colloid-producing polymeric substance selected from the class consisting of animal glue, gum arabic, amylose, gelatin, egg albumin, blood albumin, alkali metal salts of lignosulfonic acid, glycol-treated algin, saponin, Irish moss, and casein.

U.S. Pat. No. 3,682,249 teaches a method for inhibiting the deposition of wax from wax-containing soluble oils and micellar dispersion in which a small amount of a wax deposition inhibitor comprised of a copolymer of ethylene and a monoethylenically unsaturated ester is added to the soluble oil or micellar dispersion. Also disclosed are soluble oil and micellar compositions containing small amounts of the ethylene-ester copolymer.

US-2007/0173417 teaches composites containing a hydrocarbon-soluble well treatment agent which may be supplied to a well using a porous particulate. Such well treatment agents may for example inhibit the formation of paraffins, salts, gas hydrates, asphaltenes and/or other deleterious processes such as emulsification (both water-in-oil and oil-in-water). Further, other well treatment agents include foaming agents, oxygen scavengers, biocides and surfactants as well as other agents wherein slow release into the production well is desired.

A further approach to dispersions of pour point depressants consists in the emulsification of polymers dissolved in organic solvents in a nonsolvent for the polymeric active ingredient.

For instance, EP-A-0 448 166 discloses dispersions of polymers of ethylenically unsaturated compounds which comprise aliphatic hydrocarbon radicals having at least 10 carbon atoms in glycols and optionally water. The dispersions contain at least 28 wt.-% polymer and are used as pour point depressants.

WO-05/023907 discloses emulsions of at least two different polymers selected from ethylene-vinyl acetate copolymers, poly(alkyl acrylates) and alkyl acrylate-grafted ethylene-vinyl acetate copolymers which are used to lower the pour point of crude oils. The emulsions comprise 5 to 70 wt.-% polymer, water, an organic solvent, anionic, cationic and/or nonionic surfactants which are not specified any further, and a water-soluble solvent.

WO-98/33846 discloses dispersions containing at least 10 wt.-% of an ester polymer with specified side chains. The dispersions comprise an aliphatic or aromatic hydrocarbon and a second, preferably oxygen-containing solvent, for example glycol, which is a nonsolvent for the polymer, and optionally water.

U.S. Pat. No. 5,851,429 discloses dispersions in which 20 to 60 wt.-% of a room temperature solid pour point depressant is dispersed in a nonsolvent. Suitable nonsolvents mentioned include alcohols, esters, ethers, lactones, ethoxyethyl acetate, ketones, glycols and alkylglycols, and mixtures thereof with water.

WO 2008/083724 discloses dispersions comprising 5 to 60 wt.-% of at least one oil-soluble polymer that is effective as a cold flow improver for mineral oils, water, at least one organic solvent that cannot be mixed with water, at least one alkanolamine salt of a polycyclic carboxylic acid as a dispersing agent, and optionally at least one organic solvent that can be mixed with water. Due to the low viscosity and pour point of the dispersions their application to crude oil can happen above ground and equally “down-the-hole” without preceding dilution of the additives and without heating the delivery lines.

WO 2012/170241 discloses pour point depressant compositions comprising a thermoplastic polymer in an aqueous medium and a method to make and use said compositions which provide a lower pour point in crude oils. These dispersions comprise 12 to 50 wt.-% of a thermoplastic polymer, preferably ethylene vinyl acetate (EVA), a dispersing agent, water, optionally an aqueous freezing point depressant, and optionally a stabilizing agent wherein the volume average particle size of the dispersed thermoplastic polymer is equal to or less than 1 micrometers.

A drawback of polymer solutions in organic solvent and equally of polymer dispersions is the need for their continuous or at least intermittent dosage into the crude to be treated. Hence a concept of “solid” paraffin inhibitors has been developed wherein the additive is released over a sustained period of time.

US 2006/124302 discloses a concept of using water-insoluble adsorbents as carriers to incorporate well treatment agents. After deposition of the material in the formation it produces a continuous supply of the agent into the targeted area. Often such adsorbents are porous solids which are impregnated with the well treatment agents. The pores of the adsorbent assure a slow release of the agents into the produced fluid and therefore a long-term protection of the well. Examples for such deleterious effects are scale formation, corrosion of equipment and/or paraffin precipitation.

U.S. Pat. No. 7,598,209 discloses composites capable of providing a means of slowly releasing a hydrocarbon-soluble well treatment agent into a subterranean formation. They may be used e.g. in stimulation treatments as a component of a fracturing fluid. The composites are composed of a porous particulate, e.g. ceramics, and at least one hydrocarbon-soluble well treatment agent adsorbed into the interstitial spaces of the porous particulates. Preferred hydrocarbon-soluble well treatment agents are i. a. demulsifiers, corrosion inhibitors, paraffin inhibitors, asphaltene dispersants and wax crystal modifiers or a combination thereof. The wax crystal modifiers include ethylene/vinyl acetate copolymers, homopolymers and copolymers of acrylate esters, phenol-aldehyde resins and olefin/maleic ester copolymers. These impregnated porous particulates may be used with other non-porous particulates like conventional sand.

Similarly, U.S. Pat. No. 6,723,683 discloses biodegradable chemical compositions in which a chemical, particularly at least one oil well chemical is adsorbed onto particulate starch, particularly granular starch, providing a stable, controlled release formulation suitable for use in oil field applications.

U.S. Pat. No. 6,613,720 discloses means to delay the action of chemicals in a fracturing fluid for a hydrocarbon-bearing formation by sequestering the chemical in the discontinuous phase of an emulsion. Upon exposure to one or more destabilizing conditions the emulsion is disrupted, releasing the sequestered chemical or biological agent into the bulk fluid of the composition, permitting the agent to have its desired effect. The effect is shown for a delayed crosslinking of water soluble polymers.

Especially with hydraulic fracturing treatments for production of paraffin-rich hydrocarbon fluids wax precipitation becomes an increasing problem. During hydraulic fracturing operations the equilibrium balance of the crude oil is disrupted once large volumes of high-pressure fluids are injected into the formation. Fluid temperature is usually lower than reservoir temperature, and often the formation gets cooled below the cloud point respectively the wax appearance temperature of the crude oil. Although the crude oil remains well above its pour point some heavy paraffins precipitate and often deposit in the formation pores and on the faces as fractures develop. By blockage especially of small pore throats they impair the free flow of the oil and finally plug the subterranean oil bearing formation. Such reduction in formation porosity and average aperture often has significant impact on oil displacement efficiency and on conductivity of the fracture.

For paraffin-rich reservoirs, such as shale oil, especially damage caused by wax deposition at the fracture skin can cause decreased production, slow or hard to clean up wellbores, or failure to achieve predicted maximum recovery. After the fracturing treatment and start-up of oil production the temperature in the formation will only rise slowly and the amount of wax melted and/or dissolved from the formation into the oil is low. However, a formation completely plugged with paraffin wax can only be repaired when the temperature of the formation is raised above the melting point of the wax.

The known paraffin treatments are suited to cope with reduced flow of the produced oil due to paraffin crystallization and especially to gelling after the fracturing process is finished, for example in boreholes and especially in flow lines when the crude oil is cooled below its pour point. However, there remains a need to counteract wax deposition during the fracturing process and especially at and near the face of the freshly formed fracture where oil gets into contact with water the first time while remaining above its pour point. Although the oil remains well above its pour point and is capable of flowing often waxes deposit on the surface of the fresh fracture and reduce the width of the generated channels. While delivery of water soluble chemical agents to defined locations in the subterranean formation succeeds by addition of the chemical directly to the carrier fluid, this concept is not applicable to water insoluble wax inhibitors as wax inhibitors are non-polar polymers and as such not soluble in water. Similar effects may occur on gas fractures, where paraffin containing condensate is co-produced.

Furthermore, there is a need for fracturing fluids which allow for prevention respectively control of wax precipitation and especially of wax deposition in the subterranean formation during the fracturing treatment, as caused by the shifting of the equilibrium conditions in the fracturing zone, and in parallel the longer-term control of subsequent deposition in the well bore and in aboveground lines when the highly paraffinic oil cools down during the production phase. While the longer term effect can be sorted out to some extent with solid wax inhibitors as for example with impregnated proppants the short-term task cannot be solved neither with solid wax inhibitors nor with conventional wax inhibitors according to the state of the art. Solid wax inhibitors are not going to release wax inhibitors fast enough since the water cut is relatively high within the first weeks of a hydraulic fracturing job. Applied as solution in organic solvent the wax inhibitors will be creaming from typical carrier fluids. The known water-based dispersions of paraffin inhibitors are much too concentrated to be used as a carrier fluid. However, need for wax inhibitors that can be delivered via the aqueous phase to the face of the facture is paramount in the mind of investigators, as liquid travels first and deeper into reservoir than proppants. Additionally, carrier fluids and the fracturing fluids containing them shall be homogeneous, easy to prepare and they have to be stable at ambient temperatures and under reservoir conditions for at least several hours and preferably for at least a day or even more.

Surprisingly it has been found that concentrated dispersions of wax inhibitors can be mixed with large volumes of carrier fluid resulting in homogeneous, long-term stable fluids without destabilising the colloidal system and creaming of the water-insoluble wax-inhibitor. Unexpectedly, upon contact of the fracking fluid with the crude oil at the face of the freshly formed fracture the dispersed wax inhibitor is transferred into the oil phase and prevents the deposition of wax. Surprisingly such fracturing fluids containing a small amount of a wax inhibitor finely dispersed in the carrier fluid prevent the formation of wax precipitates in the formation during the fracturing treatment. This is especially advantageous in the initial stages of a fracturing treatment when huge amounts of carrier fluid are pumped into the formation for example as a prepad or pad. In addition, a solid proppant impregnated with a second wax inhibitor and/or a solid wax inhibitor admixed with proppant assures the desired wax inhibition during and after start-up of oil production. Addition of proppant impregnated with a wax inhibitor does not destabilise this system or interfere with the performance.

In a first aspect the invention thus provides a fracturing fluid comprising
i) 85 wt.-% or more of an aqueous carrier fluid as continuous phase,
ii) 0.001 to 1.5 wt.-% of a wax inhibitor being dispersed in the carrier fluid, the wax inhibitor being selected from the group consisting of
   a) copolymers of ethylene and ethylenically unsaturated esters, ethers and/or C₃ to C₃₀-alkenes,
   b) homo- or copolymers of ethylenically unsaturated carboxylic acids, bearing C₁₂-C₅₀-alkyl radicals bound via ester, amide and/or imide groups,
   c) ethylene copolymers grafted with ethylenically unsaturated esters and/or ethers,
   d) homo- and copolymers of C₃ to C₃₀-olefins, and
   e) condensation products of alkyl phenols with aldehydes and/or ketones
iv) optionally a water soluble polymer for viscosity adjustment,

wherein the amount of water-immiscible hydrocarbons is less than 2.5 wt.-%.

In a second aspect the invention provides a fracturing fluid comprising
i) 85 wt.-% or more of an aqueous carrier fluid as continuous phase,
ii) 0.001 to 1.5 wt.-% of a first wax inhibitor being dispersed in the carrier fluid, the wax inhibitor being selected from the group consisting of
   a) copolymers of ethylene and ethylenically unsaturated esters, ethers and/or C₃ to C₃₀-alkenes,
   b) homo- or copolymers of ethylenically unsaturated carboxylic acids, bearing C₁₂-C₅₀-alkyl radicals bound via ester, amide and/or imide groups,
   c) ethylene copolymers grafted with ethylenically unsaturated esters and/or ethers,
   d) homo- and copolymers of C₃ to C₃₀-olefins, and
   e) condensation products of alkyl phenols with aldehydes and/or ketones
iii) a water insoluble solid proppant,
iv) optionally a water soluble polymer for viscosity adjustment,

wherein the amount of water-immiscible hydrocarbons is less than 2.5 wt.-%.

In a third aspect the invention provides a process for preparing a fracturing fluid comprising
i) 85 wt.-% or more of an aqueous carrier fluid as continuous phase,
ii) 0.001 to 1.5 wt.-% of a first wax inhibitor being dispersed in the carrier fluid, the wax inhibitor being selected from the group consisting of
   a) copolymers of ethylene and ethylenically unsaturated esters, ethers and/or C₃ to C₃₀-alkenes,
   b) homo- or copolymers of ethylenically unsaturated carboxylic acids, bearing C₁₂-C₅₀-alkyl radicals bound via ester, amide and/or imide groups,
   c) ethylene copolymers grafted with ethylenically unsaturated esters and/or ethers,
   d) homo- and copolymers of C₃ to C₃₀-olefins, and
   e) condensation products of alkyl phenols with aldehydes and/or ketones
iii) optionally a water insoluble solid proppant,
iv) optionally a water soluble polymer for viscosity adjustment,

wherein the amount of water-immiscible hydrocarbons is less than 2.5 wt.-% by continuously injecting a concentrated (5-70 wt.-% active) dispersion of the first wax inhibitor into a stream of carrier fluid at temperatures between 10° C. and 60° C.

In a fourth aspect the invention provides a process for inhibiting wax precipitation during fracturing of a subterranean formation comprising injecting into the well bore a fracturing fluid comprising
i) 85 wt.-% or more of an aqueous carrier fluid,
ii) 0.001 to 1.5 wt.-% of a first wax inhibitor being dispersed in the carrier fluid, the wax inhibitor being selected from the group consisting of
   a) copolymers of ethylene and ethylenically unsaturated esters, ethers and/or C₃ to C₃₀-alkenes,
   b) homo- or copolymers of ethylenically unsaturated carboxylic acids, bearing C₁₂-C₅₀-alkyl radicals bound via ester, amide and/or imide groups,
   c) ethylene copolymers grafted with ethylenically unsaturated esters and/or ethers,
   d) homo- and copolymers of C₃ to C₃₀-olefins, and
   e) condensation products of alkyl phenols with aldehydes and/or ketones
iii) optionally a water insoluble solid proppant,
iv) optionally a water soluble polymer for viscosity adjustment,

wherein the amount of water-immiscible hydrocarbons is less than 2.5 wt.-%

In a fifth aspect the invention further provides the use of a wax inhibitor dispersed in the aqueous carrier fluid in a fracturing process for the suppression of wax precipitation at the subterranean fracture face wherein the carrier fluid is part of a fracturing fluid comprising
i) 85 wt.-% or more of an aqueous carrier fluid,
ii) 0.001 to 1.5 wt.-% of a first wax inhibitor being dispersed in the carrier fluid, the wax inhibitor being selected from the group consisting of
   a) copolymers of ethylene and ethylenically unsaturated esters, ethers and/or C₃ to C₃₀-alkenes,
   b) homo- or copolymers of ethylenically unsaturated carboxylic acids, bearing C₁₂-C₅₀-alkyl radicals bound via ester, amide and/or imide groups,
   c) ethylene copolymers grafted with ethylenically unsaturated esters and/or ethers,
   d) homo- and copolymers of C₃ to C₃₀-olefins, and
   e) condensation products of alkyl phenols with aldehydes and/or ketones
iii) optionally a water insoluble solid proppant,
iv) optionally a water soluble polymer for viscosity adjustment,

wherein the amount of water-immiscible hydrocarbons is less than 2.5 wt.-%

In preferred embodiments of the second, third, fourth and/or fifth aspect of the invention the solid proppant contains an immobilized second wax inhibitor.

The carrier fluid may be fresh water, salt water or preferably brine, according to availability. The fracturing fluids of the invention preferably contain 85 to 99.9 wt.-%, more preferably 90 to 99 wt.-% and especially 92 to 97 wt.-% as for example 85 to 99 wt.-%, 85 to 97 wt.-%, 90 to 99.9 wt.-%, 90 to 97 wt.-%, 92 to 99.9 wt.-% or 92 to 99 wt.-% of the carrier fluid. Brine is understood to contain water and more than 2.6 percent salt (the amount contained in sea water).

The inventive composition is essentially free of water-immiscible hydrocarbon compounds. Essentially free means that the inventive composition contains 2.5 wt.-% or less, preferably 2 wt.-% or less, more preferably 1.5 wt.-% or less, as for example 1 wt.-% or less of water-immiscible hydrocarbon compounds. The expression water-immiscible refers to a solubility of the respective compound of less than 1 g/I in water at 25° C.

The description of the preferred wax inhibitors refers to both the first and the second wax inhibitor. Preferred first and second wax inhibitors in the various aspects of the invention are, for example,
a) copolymers of ethylene and ethylenically unsaturated esters, ethers and/or C₃ to C₃₀-alkenes,
b) homo- or copolymers of ethylenically unsaturated carboxylic acids, bearing C₁₂-C₅₀-alkyl radicals bound via ester, amide and/or imide groups,
c) ethylene copolymers grafted with ethylenically unsaturated esters and/or ethers,
d) homo- and copolymers of C₃ to C₃₀-olefins, and
e) condensation products of alkyl phenols with aldehydes and/or ketones.

Suitable copolymers of ethylene and ethylenically unsaturated esters, ethers or alkenes (a) are especially those which, as well as ethylene, contain 4 to 18 mol-%, especially 7 to 15 mol-%, of at least one vinyl ester, acrylic ester, methacrylic ester, alkyl vinyl ether and/or alkene.

The vinyl esters are preferably those of the formula (1)

CH₂═CH—OCOR¹ (1)

in which
R¹ is C₁- to C₃₀-alkyl, preferably C₄- to C₁₆-alkyl, especially C₆- to C₁₂-alkyl as for example C₁- to C₁₆-alkyl, C₁- to C₁₂-alkyl, C₄- to C₃₀-alkyl, C₄- to C₁₂-alkyl, C₆- to C₃₀-alkyl or C₆- to C₁₆-alkyl.

The alkyl radicals may be linear or branched. In a preferred embodiment, the alkyl radicals are linear alkyl radicals having 1 to 18 carbon atoms. In a further preferred embodiment, R¹ is a branched alkyl radical having 3 to 30 carbon atoms and preferably having 5 to 16 carbon atoms. Particularly preferred vinyl esters are derived from secondary and especially tertiary carboxylic acids whose branch is in the alpha position to the carbonyl group. Especially preferred are the vinyl esters of tertiary carboxylic acids which are also known as Versatic acid vinyl esters and which possess neoalkyl radicals having 5 to 11 carbon atoms, especially having 8, 9 or 10 carbon atoms. Suitable vinyl esters include vinyl acetate, vinyl propionate, vinyl butyrate, vinyl isobutyrate, vinyl hexanoate, vinyl heptanoate, vinyl octanoate, vinyl pivalate, vinyl 2-ethylhexanoate, vinyl laurate, vinyl stearate, and Versatic esters such as vinyl neononanoate, vinyl neodecanoate, vinyl neoundecanoate.

An especially preferred vinyl ester is vinyl acetate.

In a further embodiment, the alkyl groups mentioned may be substituted by one or more hydroxyl groups.

In a further preferred embodiment, these ethylene copolymers contain vinyl acetate and at least one further vinyl ester of the formula 1 in which R¹ is C₄- to C₃₀-alkyl, preferably C₄- to C₁₆-alkyl and especially C₆- to C₁₂-alkyl. Preferred further vinyl esters are the above-described vinyl esters of this chain length range.

The acrylic and methacrylic esters are preferably those of the formula (2)

CH₂═CR²—COOR³ (2)

in which
R² is hydrogen or methyl and
R³ is C₁- to C₃₀-alkyl, preferably C₄- to C₂₄-alkyl, especially C₆- to C₁₈-alkyl as for example C₁- to C₁₈-alkyl, C₁- to C₂₄-alkyl, C₄- to C₃₀-alkyl, C₄- to C₁₈-alkyl, C₆- to C₃₀-alkyl or C₆- to C₂₄-alkyl.

The alkyl radicals may be linear or branched. In a preferred embodiment, they are linear. In a further preferred embodiment, they possess a branch in the 2 position to the ester moiety. Suitable acrylic esters include, for example, methyl (meth)acrylate, ethyl (meth)acrylate, propyl (meth)acrylate, n- and isobutyl (meth)acrylate, and hexyl-, octyl-, 2-ethylhexyl-, 2-propylheptyl-, 4-methyl-2-propylhexyl-, decyl-, dodecyl-, tetradecyl-, hexadecyl-, octadecyl- and eicosyl (meth)acrylate, and mixtures of these comonomers, the formulation “(meth)acrylate” including the corresponding esters of acrylic acid and of methacrylic acid.

The alkyl vinyl ethers are preferably compounds of the formula (3)

CH₂═CH—OR⁴ (3)

in which
R⁴ is to C₃₀-alkyl, preferably C₄- to C₁₆-alkyl, especially C₆- to C₁₂-alkyl as for example C₁- to C₁₆-alkyl, C₁- to C₁₂-alkyl, C₄- to C₃₀-alkyl, C₄- to C₁₂-alkyl, C₆- to C₃₀-alkyl or C₆- to C₁₆-alkyl.

The alkyl radicals may be linear or branched. Examples include methyl vinyl ether, ethyl vinyl ether, isobutyl vinyl ether.

The alkenes are preferably monounsaturated hydrocarbons having 3 to 30 carbon atoms, more particularly 4 to 16 carbon atoms and especially 5 to 12 carbon atoms as for example 3 to 16 carbon atoms, 3 to 12 carbon atoms, 4 to 30 carbon atoms, 4 to 12 carbon atoms, 5 to 30 carbon atoms or 5 to 16 carbon atoms. Suitable alkenes include propene, butene, isobutene, pentene, hexene, 4-methylpentene, heptene, octene, decene, diisobutylene and norbornene, and derivatives thereof such as methylnorbornene and vinylnorbornene.

The alkyl radicals R¹, R³ and R⁴ may bear minor amounts of functional groups, for example amino, amido, nitro, cyano, hydroxyl, keto, carbonyl, carboxyl, ester and sulfo groups and/or halogen atoms, provided that they do not significantly impair the hydrocarbon character of the radicals mentioned.

Particularly preferred terpolymers contain, apart from ethylene, preferably 3.5 to 17 mol-% and especially 5 to 15 mol-% of vinyl acetate, and 0.1 to 10 mol-% and especially 0.2 to 5 mol-% of at least one long-chain vinyl ester, (meth)acrylic ester, vinyl ether and/or alkene, where the total comonomer content is between 4 and 18 mol-% and preferably between 7 and 15 mol-%. Particularly preferred termonomers are vinyl 2-ethylhexanoate, vinyl neononanoate; vinyl neodecanoate 2-ethyl hexyl acrylate, 2-propyl heptylacrylate, 4-methyl-2-propyl hexylacrylate and their mixtures. Further particularly preferred copolymers contain, in addition to ethylene and 3.5 to 17.5 mol-% of vinyl esters, also 0.1 to 10 mol-% of olefins such as propene, butene, isobutene, hexene, 4-methylpentene, octene, diisobutylene, norbornene and/or styrene.

The number average molecular weight of the ethylene copolymers (a) as determined by gel permeation chromatography in THF against poly(styrene) standards is preferably between 2.000 and 50.000 and especially between 2.500 and 30.000 g/mol as for example between 2.000 and 30.000 g/mol or between 3.000 and 50.000 g/mol. The mass average molecular weight is preferably between 5.000 and 300.000 g/mol and especially between 7.000 and 250.000 g/mol as for example between 5.000 and 250.000 g/mol or between 7.000 and 300.000 g/mol. The MFI₁₉₀ values of the ethylene copolymers (a), measured according to DIN 53735 at 190° C. and an applied load of 2.16 kg, are preferably between 0.1 and 1200 g/10 min and especially between 1 and 900 g/10 min. The degrees of branching determined by means of ¹H NMR spectroscopy are preferably between 1 and 9 CH₃/100 CH₂ groups, especially between 2 and 6 CH₃/100 CH₂ groups, which do not originate from the comonomers.

Preference is given to using mixtures of two or more of the abovementioned ethylene copolymers. The polymers on which the mixtures are based more preferably differ in at least one characteristic. For example, they may contain different comonomers, different comonomer contents, molecular weights and/or degrees of branching.

The copolymers (a) are prepared by known processes (on this subject, see, for example, Ullmanns Encyclopädie der Technischen Chemie, 5^{th} edition, vol. A 21, pages 305 to 413). Suitable methods are polymerization in solution, in suspension and in the gas phase, and high-pressure bulk polymerization. Preference is given to employing high-pressure bulk polymerization, which is performed at pressures of 50 to 400 MPa, preferably 100 to 300 MPa, and temperatures of 50 to 350° C., preferably 100 to 300° C. The reaction of the comonomers is initiated by free-radical-forming initiators (free-radical chain initiator). This substance class includes, for example, oxygen, hydroperoxides, peroxides and azo compounds, such as cumene hydroperoxide, t-butyl hydroperoxide, dilauroyl peroxide, dibenzoyl peroxide, bis(2-ethylhexyl) peroxodicarbonate, t-butyl permaleate, t-butyl perbenzoate, dicumyl peroxide, t-butyl cumyl peroxide, di(t-butyl peroxide, 2,2′-azobis(2-methylpropanonitrile), 2,2′-azobis(2-methylbutyronitrile).

The desired molecular weight of the copolymers (a), for a given composition of the comonomer mixture, is adjusted by varying the reaction parameters of pressure and temperature, and if appropriate by adding moderators. Useful moderators have been found to be hydrogen, saturated or unsaturated hydrocarbons, for example propane and propene, aldehydes, for example propionaldehyde, n-butyraldehyde and isobutyraldehyde, ketones, for example acetone, methyl ethyl ketone, methyl isobutyl ketone and cyclohexanone, or alcohols, for example butanol. Depending on the desired viscosity, the moderators are employed in amounts up to 20% by weight, preferably 0.05 to 10% by weight, based on the comonomer mixture.

Suitable homo- or copolymers of ethylenically unsaturated carboxylic acids bearing C₁₂-C₅₀-alkyl radicals bound via ester, amide and/or imide groups, (b), are especially those which contain repeat structural elements of the formula (4)

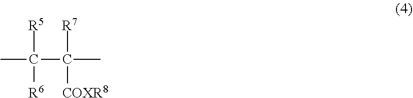

wherein
R⁵ and R⁶ are each independently hydrogen, phenyl or a group of the formula COXR⁸,
R⁷ is hydrogen, methyl or a group of the formula —CH₂COXR⁸
X is O, NH or NR⁸ and
R⁸ is a C₁₂- to C₅₀-alkyl or -alkylene radical, preferably a C₁₄- to C₃₀-alkyl or -alkylene radical and especially a C₁₈- to C₂₄-alkyl or -alkylene radical as for example a C₁₂- to C₃₀-alkyl or -alkylene radical, a C₁₂- to C₂₄-alkyl or -alkylene radical, a C₁₄- to C₅₀-alkyl or -alkylene radical, a C₁₄- to C₂₄-alkyl or -alkylene radical, a C₁₈- to C₅₀-alkyl or -alkylene radical or a C₁₈- to C₃₀-alkyl or -alkylene radical, with the proviso that these repeat structural units contain at least one and at most two carboxylic ester and/or amide units in one structural element.

Particularly suitable homo- and copolymers are those in which R⁵ and R⁶ are each hydrogen or a group of the formula COOR⁸ and R⁷ is hydrogen or methyl. These structural units derive from esters of monocarboxylic acids, for example from acrylic acid, methacrylic acid, cinnamic acid, or from mono- or diesters of dicarboxylic acids, for example from maleic acid, fumaric acid and itaconic acid. Particular preference is given to the esters of acrylic acid.

Alcohols suitable for the esterification of the ethylenically unsaturated mono- and dicarboxylic acids are those having 12 to 50 carbon atoms, preferably those having 14 to 30 carbon atoms and especially those having 18 to 24 carbon atoms as for example those having 12 to 30 carbon atoms, 12 to 24 carbon atoms, 14 to 50 carbon atoms, 14 to 24 carbon atoms, 18 to 50 carbon atoms or 18 to 30 carbon atoms. They may be of natural or synthetic origin. The alkyl radicals are preferably linear or at least substantially linear. Suitable fatty alcohols include 1-decanol, 1-dodecanol, 1-tridecanol, isotridecanol, 1-tetradecanol, 1-hexadecanol, 1-octadecanol, eicosanol, docosanol, tetracosanol, hexacosanol and their mixtures including naturally occurring mixtures, for example coconut fatty alcohol, tallow fatty alcohol, hydrogenated tallow fatty alcohol and behenyl alcohol.

The copolymers of constituent (b) may, besides the C₁₂-C₅₀-alkyl esters of unsaturated carboxylic acids, comprise further comonomers such as vinyl esters of the formula (1), relatively short-chain (meth)acrylic esters of the formula (2), alkyl vinyl ethers of the formula (3) and/or alkenes. Preferred vinyl esters correspond to the definition given for formula (1). Particular preference is given to vinyl acetate. Preferred alkenes are α-olefins, i.e. linear olefins with a terminal double bond, preferably with chain lengths of 6 to 50 and more particularly with 10 to 36, especially with 16 to 30, more especially with 18 to 24 as for example with 10 to 50, with 10 to 30, with 10 to 24, with 16 to 50, with 16 to 36, with 16 to 24, with 18 to 50, with 18 to 36 or with 18 to 30 carbon atoms. Examples of suitable α-olefins are propene, 1-butene, isobutene, 1-octene, 1-nonene, 1-decene, 1-dodecene, 1-tridecene, 1-tetradecene, 1-pentadecene, 1-hexadecene, 1-heptadecene, 1-octadecene, 1-nonadecene, 1-eicosene, 1-henicosene, 1-docosene, 1-tetracosene and their mixtures. Likewise suitable are commercially available chain cuts, for example C₁₃₋₁₈-α-olefins, C₁₂₋₁₆-α-olefins, C₁₄₋₁₆-α-olefins, C₁₄₋₁₈-α-olefins, C₁₆₋₁₈-α-olefins, C₁₆₋₂₀-α-olefins, C₂₂₋₂₈-α-olefins, C₃₀₊-α-olefins.

Additionally suitable as comonomers in constituent (b) are especially ethylenically unsaturated compounds bearing further heteroatoms, the heteroatoms preferably being selected from oxygen and nitrogen. Examples for such comonomers are allyl polyglycols, benzyl acrylate, hydroxyethyl acrylate, hydroxypropyl acrylate, hydroxybutyl acrylate, dimethylaminoethyl acrylate, perfluoroalkyl acrylate, amides of (meth)acrylic acid, vinylpyridine, vinylpyrrolidone, acrylic acid, methacrylic acid, p-acetoxystyrene and vinyl methoxyacetate. Their proportion in the polymer is preferably less than 20 mol-%, especially between 1 and 15 mol-%, for example between 2 and 10 mol-% as for example between 1 and 20 mol-%, between 2 and 20 mol-% or between 1 and 10 mol-%.

Allyl polyglycols suitable as comonomers may, in a preferred embodiment of the invention, comprise 1 to 50 ethoxy and/or propoxy units and correspond to the formula (5):

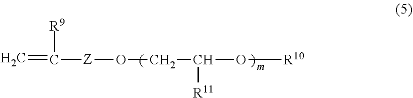

in which
R⁹ is hydrogen or methyl,
Z is C₁-C₃-alkyl,
R¹⁰ is hydrogen, C₁-C₃₀-alkyl, cycloalkyl, aryl or —C(O)—R¹²,
R¹¹ is hydrogen or C₁-C₂₀-alkyl,
R¹² is C₁-C₃₀-alkyl, C₃-C₃₀-alkenyl, cycloalkyl or aryl and
m is from 1 to 50, preferably 1 to 30.

Particular preference is given to comonomers of the formula 5 in which R⁹ and R¹¹ are each hydrogen, R¹⁰ is hydrogen or a C₁-C₄-alkyl group and Z is a methylene group.

Preferred homo- or copolymers (b) contain at least 10 mol-%, more preferably 20 to 95 mol-%, particularly 30 to 80 mol-%, especially 40 to 60 mol-% as for example at least 30 mol-%, at least 40 mol-%, 10 to 95 mol-%, 10 to 80 mol-%, 10 to 60 mol-%, 20 to 80 mol-% or 30 to 95 mol-% of structural units derived from esters of ethylenically unsaturated carboxylic acids, said esters bearing C₁₂-C₅₀-alkyl radicals. In a specific embodiment, the wax inhibitors (b) consist of structural units derived from esters of ethylenically unsaturated carboxylic acids, said esters bearing C₁₂-C₅₀-alkyl radicals as outlined above.

Preferred homo- or copolymers of esters of ethylenically unsaturated carboxylic acids (b), said esters bearing C₁₂-C₅₀-alkyl radicals, are, for example, poly(alkyl acrylates), poly(alkyl methacrylates), copolymers of alkyl (meth)acrylates with vinylpyridine, copolymers of alkyl (meth)acrylates with allyl polyglycols, esterified and/or amidated copolymers of alkyl (meth)acrylates with maleic anhydride, copolymers of esterified and/or amidated ethylenically unsaturated dicarboxylic acids, for example dialkyl maleates or fumarates, with α-olefins, copolymers of esterified and/or amidated ethylenically unsaturated dicarboxylic acids, for example dialkyl maleates or fumarates, with unsaturated vinyl esters, for example vinyl acetate, copolymers of esterified ethylenically unsaturated dicarboxylic acids, for example dialkyl maleates or fumarates, with styrene, or else copolymers of amidated and7or imidized ethylenically unsaturated dicarboxylic acids, for example dialkyl maleamides or dialkyl fumaramides with α-olefins.

The molecular weights or molar mass distributions of preferred copolymers (b) are characterized by a K value (measured according to Fikentscher in 5% solution in toluene) of 10 to 100, preferably 15 to 80. The weight average molecular weights (Mw) may be within a range from 5,000 to 1,000,000 g/mol, preferably from 10,000 to 300,000 g/mol and especially from 25,000 to 100,000 g/mol as for example from 5,000 to 300,000 g/mol, from 5,000 to 100,000 g/mol, from 10,000 to 1,000,000 g/mol, from 10,000 to 100,000 g/mol, from 25,000 to 1,000,000 g/mol or from 25,000 to 300,000 g/mol as determined by means of gel permeation chromatography GPC against poly(styrene) standards.

The copolymers (b) are prepared typically by (co)polymerizing esters, amides and/or imides of ethylenically unsaturated carboxylic acids, especially alkyl acrylates and/or alkyl methacrylates, optionally with further comonomers, by customary free-radical polymerization methods. Controlled radical chain reaction protocols are equally suited.

A further means of preparing the wax inhibitors (b) consists in the polymer-analogous esterification or transesterification of already polymerized ethylenically unsaturated carboxylic acids, the esters thereof with short-chain alcohols, or the reactive equivalents thereof, for example acid anhydrides with fatty alcohols having 12 to 50 carbon atoms. For example, the transesterification of poly(meth)acrylic acid with fatty alcohols leads to wax inhibitors (b) suitable in accordance with the invention. An especially preferred class of wax inhibitors (b) can be prepared by copolymerisation of unsaturated dicarboxylic acid anhydrides and especially of maleic anhydride with the comonomers described above in essentially equimolar amounts and subsequent esterification of the copolymers with fatty alcohols having 10 to 50 carbons atoms as described above. Similarly said copolymers of maleic anhydride with α-olefins can be amidated and/or imidized with amines having at least one C₁₂-C₅₀ alkyl residue and especially having at least one C₁₄-C₂₄ alkyl residue.

Suitable ethylene copolymers (c) grafted with ethylenically unsaturated esters are, for example, those which comprise
A) an ethylene copolymer which, in addition to ethylene, contains 4 to 20 mol-% and preferably 6 to 18 mol-% of at least one vinyl ester, acrylic ester, methacrylic ester, alkyl vinyl ether and/or alkene, onto which
B) a homo- or copolymer of an ester of an α,ß-unsaturated carboxylic acid with a C₁₂- to C₅₀-alcohol has been grafted.

In general, the ethylene copolymer (A) is one of the copolymers described as wax inhibitors (a). Ethylene copolymers preferred as the copolymer (A) for the grafting are especially those which, in addition to ethylene, contain 7.5 to 15 mol-% of vinyl acetate. In addition, preferred ethylene copolymers (A) possess MFI₁₉₀ values between 1 and 900 g/min and especially between 2 and 500 g/min as for example between 1 and 500 g/min or between 2 and 900 g/min.

The (co)polymers (B) grafted onto the ethylene copolymers (A) contain preferably 40 to 100% by weight and especially 50 to 90% by weight as for example 40 to 90% by weight or 50 to 100% by weight of one or more structural units derived from alkyl acrylates and/or alkyl methacrylates. Preferably at least 10 mol-%, more preferably 20 to 100 mol-%, particularly 30 to 90 mol-% and especially 40 to 70 mol-% as for example more than 20 mol-%, more than 30 mol-%, 10 to 100 mol-%, 10 to 90 mol-%, 10 to 70 mol-%, 20 to 90 mol-%, 20 to 70 mol-%, 30 to 100 mol-%, 30 to 70 mol-%, 40 to 100 mol-% or 40 to 70 mol-% of the grafted structural units bear alkyl radicals having at least 12 carbon atoms. Particularly preferred monomers are alkyl (meth)acrylates having C₁₂-C₅₀-alkyl radicals, more preferably having C₁₄-C₃₀-alkyl radicals and especially having C₁₈-C₂₄-alkyl radicals, for example having C₁₈-C₅₀-alkyl radicals, C₁₈-C₃₀-alkyl radicals, C₁₈-C₂₄-alkyl radicals or C₂₀₋₀₂₄-alkyl radicals. Preferred alcohols for the preparation of the alkyl acrylates and/or methacrylates are the same as described for the preparation of the esters of unsaturated carboxylic acids used for the preparation of polymers (b).

The grafted (co)polymers (B) optionally contain 0 to 60% by weight, preferably 10 to 50% by weight, of one or more further structural units which derive from further ethylenically unsaturated compounds. Suitable further ethylenically unsaturated compounds are, for example, vinyl esters of carboxylic acids having 1 to 20 carbon atoms, α-olefins having 6 to 40 carbon atoms, vinyl aromatics, dicarboxylic acids and anhydrides and esters thereof with C₁₀-C₅₀-fatty alcohols, acrylic acid, methacrylic acid and especially ethylenically unsaturated compounds bearing heteroatoms, for example benzyl acrylate, hydroxyethyl acrylate, hydroxypropyl acrylate, hydroxybutyl acrylate, p-acetoxystyrene, vinyl methoxyacetate, dimethylaminoethyl acrylate, perfluoroalkyl acrylate, the isomers of vinylpyridine and derivatives thereof, N-vinylpyrrolidone and (meth)acrylamide and derivatives thereof, such as N-alkyl (meth)acrylamides with C₁-C₂₀-alkyl radicals. Also suitable as further ethylenically unsaturated compounds are allyl polyglycols of the formula (5) in which R⁹, R¹⁰, R¹¹, R¹², Z and m each have the definitions given under (b).

The graft polymers (c) usually contain ethylene copolymer (A) and homo- or copolymer of an ester of an α,ß-unsaturated carboxylic acid with a C₁₂- to C₅₀-alcohol (B) in a weight ratio of 1:10 to 10:1, preferably of 1:8 to 5:1, for example of 1:5 to 1:1.

Graft polymers (c) are prepared by known methods. For example, the graft polymers (c) are obtainable by mixing ethylene copolymer (A) and comonomer or comonomer mixture for preparation of (B), optionally in the presence of an organic solvent, and adding a free-radical chain initiator.

Suitable homo- and copolymers of higher olefins (d) are polymers of α-olefins having 3 to 30 carbon atoms. These may derive directly from monoethylenically unsaturated monomers, or be prepared indirectly by hydrogenation of polymers which derive from polyunsaturated monomers such as isoprene or butadiene. Preferred copolymers contain structural units which derive from α-olefins having 3 to 24 carbon atoms and especially 3 to 12 carbon atoms. The weight average molecular weight may be up to 150,000 g/mol, preferably it is between 1,000 and 100,000 g/mol and especially between 2,000 and 50,000 g/mol as for example between 1,000 and 150,000 g/mol, between 1,000 and 50,000 g/mol, between 2,000 and 150,000 g/mol or between 2,000 and 100,000 g/mol as determined by GPC against poly(styrene) standards. Preferred α-olefins are propene, butene, isobutene, n-hexene, isohexene, n-octene, isooctene, n-decene, isodecene. In addition, these polymers may also contain minor amounts of ethylene-derived structural units. These copolymers may also contain small amounts, for example up to 10 mol-%, of further comonomers, for example nonterminal olefins or nonconjugated olefins. Particular preference is given to ethylene-propylene copolymers. Additionally preferred are copolymers of different olefins having 5 to 30 carbon atoms, for example poly(hexene-co-decene). They may either be copolymers of random structure, or else block copolymers. The olefin homo- and copolymers can be prepared by known methods, for example by means of Ziegler or metallocene catalysts.

Suitable condensation products of alkyl substituted phenols and aldehydes and/or ketones (e) are especially those polymers which include structural units which have at least one phenolic OH group, i.e. one OH group bonded directly to the aromatic system, and at least one alkyl, alkenyl, alkyl ether or alkyl ester group bonded to the aromatic system.

Preferred wax inhibitors (e) contain oligo- or polymers with a repeat structural unit of the formula (6)

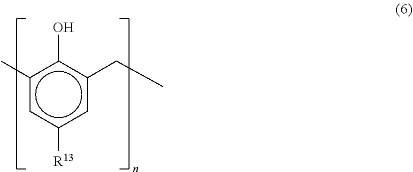

in which
R¹³ is C₁-C₂₀₀-alkyl or C₂-C₂₀₀-alkenyl, O—C₁-C₂₀₀-alkyl or O—C₂-C₂₀₀-alkenyl, C(O)—O—C₁-C₂₀₀-alkyl or C(O)—O—C₂-C₂₀₀-alkenyl, O—C(O)—C₁-C₂₀₀-alkyl or O—C(O)—C₂-C₂₀₀-alkenyl and n is from 2 to 250.

Preferably, the alkyl and alkenyl residues in the radicals R¹³ possess 2 to 100, preferably 4 to 50 and especially 6 to 36 carbon atoms as for example 2 to 50 carbon atoms, 2 to 36 carbon atoms, 4 to 100 carbon atoms, 4 to 36 carbon atoms or 6 to 50 carbon atoms. The alkyl radicals may be linear or branched, preferably they are linear. Examples of preferred alkyl radicals are n-, iso- and tert-butyl, n- and isopentyl, n- and isohexyl, n- and isooctyl, n- and isononyl, n- and isodecyl, n- and isododecyl, tetradecyl, hexadecyl, octadecyl, tripropenyl, tetrapropenyl, poly(propenyl) and poly(isobutenyl) radicals, and also essentially linear alkyl radicals derived from commercially available raw materials, for example α-olefin chain cuts or fatty acids in the chain length range of, for example, C₁₃₋₁₈, C₁₂₋₁₆, C₁₄₋₁₆, C₁₄₋₁₈, C₁₆₋₁₈, C₁₆₋₂₀, C₂₂₋₂₈ and C₃₀₊.

Preferably n is from 3 to 100, more preferably from 5 to 50 and especially from 10 to 35 as for example from 3 to 50, from 3 to 35, from 5 to 100, from 5 to 35, from 10 to 100 or from 10 to 50. The molecular weight of suited alkyl substituted phenol-aldehyde resins may vary within wide limits. However, a prerequisite for their suitability is that the alkyl substituted phenol-aldehyde resin is oil-soluble at least in concentrations relevant to use of 0.001 to 1% by weight. The number average molecular weight measured by means of gel permeation chromatography (GPC) against polystyrene standards in THF is preferably between 400 and 50,000 g/mol, more preferably between 800 and 30,000 g/mol and especially between 1,000 and 20,000 g/mol as for example between 400 and 30,000 g/mol, between 400 and 20,000 g/mol, between 800 and 50,000 g/mol, 800 and 30,000 g/mol, 1,000 and 50,000 g/mol or between 1,000 and 30,000 g/mol.

Suitable aldehydes for the preparation of the alkyl substituted phenol-aldehyde resins are those having 1 to 12 carbon atoms and preferably those having 1 to 4 carbon atoms, for example formaldehyde, acetaldehyde, propionaldehyde, butyraldehyde, 2-ethylhexanal, benzaldehyde, glyoxalic acid, and the reactive equivalents thereof, such as paraformaldehyde and trioxane. Particular preference is given to formaldehyde.

In a preferred embodiment, the condensation products of alkyl substituted phenols and aldehydes or ketones (e) are alkyl phenol-aldehyde resins. Alkylphenol-aldehyde resins are known in principle and are described, for example, in Rompp Chemie Lexikon, 9^{th} edition, Thieme Verlag 1988-92, Volume 4, p. 3351 ff. Preferred alkyl phenol-aldehyde resins in accordance with the invention are especially those which derive from alkyl phenols having one or two alkyl radicals in the ortho and/or para position to the OH group. Particularly preferred starting materials are alkyl phenols which bear at least two hydrogen atoms capable of condensation with aldehydes on the aromatic, and especially monoalkylated phenols whose alkyl radical is in the para position. The alkyl radicals may be the same or different in the alkyl phenol-aldehyde resins usable according to the invention. They may be saturated or unsaturated, preferably they are saturated. Particularly suitable alkyl phenol-aldehyde resins derive from alkyl phenols with branched alkyl radicals having 8 or 9 carbon atoms. Further particularly suitable alkyl phenol-aldehyde resins derive from alkyl phenols with a linear alkyl radical in the chain length range of C₂₀ to C₃₆.

The alkyl substituted phenol-aldehyde resins suitable in accordance with the invention are obtainable by known methods, for example by condensing the corresponding alkyl substituted phenols with formaldehyde, i.e. with 0.5 to 1.5 mol and preferably 0.8 to 1.2 mol as for example with 0.5 to 1.2 mol or with 0.8 to 1.5 mole of formaldehyde per mole of alkyl substituted phenol. The condensation can be effected without solvent, but is preferably effected in the presence of a water-immiscible or only partly water-miscible inert organic solvent, such as mineral oils, alcohols, ethers and the like. Solvents based on biogenic raw materials, such as fatty acid methyl esters, are also suitable as reaction media.

The chain ends of the alkyl substituted phenol-aldehyde resins may be modified during or after the condensation reaction, e.g. by conducting the condensation in the presence of unsaturated fatty acids or their derivatives as for example their esters with C₁-C₄-alcohols or by subsequent reaction with an amine in the presence of further alkyl substituted phenol and an aldehyde (Mannich-reaction).

The first as well as the second wax inhibitor may comprise a single wax inhibitor or a mixture of two or more different wax inhibitors. By combination of different wax inhibitors the performance profile of the wax inhibitor can be tailored to the crude to be treated. When mixtures are applied the components may belong to different groups (a) to (e), for instance they may comprise a combination of wax inhibitors selected from groups (a)+(b), (a)+(c), (a)+(d), (a)+(e), (b)+(c), (b)+(d), (b)+(e), (c)+(d), (c)+(e) or (d)+(e). Furthermore, the wax inhibitors may belong to the same group but differ in their chemical and/or physicochemical properties like molecular weight, degree of branching, kind of comonomers, proportion of comonomers and/or alkyl chain length. For instance, binary and ternary mixtures of polymers have been successfully applied. For ternary and higher mixtures the above mixtures may be combined with one or more further wax inhibitor of groups (a) to (e). In the case of mixtures, the individual components are used typically with a proportion of 5 to 95% by weight, preferably 10 to 90% by weight and especially 20 to 80% by weight, as for example 5 to 90% by weight, 5 to 80% by weight, 10 to 95% by weight, 10 to 80% by weight, 20 to 95% by weight or 20 to 90% by weight based on the total amount of wax inhibitor used with the sum of the components not exceeding 100%. The first wax inhibitor and the second wax inhibitor may be the same or different. In case they are different the combination of wax inhibitors is made according to the same principles as detailed above for mixtures of the first respectively the second wax inhibitor.

Dispersions of wax inhibitors according to the different aspects of the invention are fluids in which fine particles of a wax inhibitor are dispersed in an aqueous continuous liquid phase. Besides water, the continuous liquid phase may contain a water soluble organic solvent like e. g. methanol, ethanol, ethylene glycol, propylene glycol or glycerol. When a water soluble organic solvent is present it is part of the continuous phase jointly with water. Additionally the continuous phase may contain salts. In the dispersions the wax inhibitor may be in liquid or solid state. The wax inhibitor may be the neat active polymer or preferably a solution in an essentially water insoluble organic, preferably aromatic solvent.

Dispersions of wax inhibitors (a) to (e) can be prepared according to known procedures. In a preferred embodiment the polymerisation reaction to produce the wax inhibitors takes place solvent free or in an organic solvent. Preferred solvents are aliphatic hydrocarbons, aromatic hydrocarbons and their mixtures. Subsequently the polymer respectively its solution in aliphatic and/or aromatic hydrocarbon is dispersed in a nonsolvent, preferably in water or in a mixture of water with a polar organic solvent miscible with water as for example with ethanol, propanol, ethylene glycol, C₁-C₃-alkylethers of ethylene glycol, diethylene glycol and/or glycerol. The ratio between water and the water-miscible solvents is preferably between 1:5 to 10:1, more preferred between 1:3 and 5:1 and especially between 1:2 and 3:1 as for example between 1:5 to 5:1 or between 1:5 and 3:1 or between 1:3 and 10:1 or between 1:3 and 3:1 or between 1:2 and 5:1.

The use of a solution or dispersion of the wax inhibitor in an organic solvent being immiscible with water often proved to be advantageous. Preferred organic solvents immiscible with water are aliphatic hydrocarbons, aromatic hydrocarbons and their mixtures. If the wax inhibitor is applied in a water immiscible organic solvent the share of solvent in the wax inhibitor may be up to 70 wt.-%, preferably it is between 5 and 60 wt.-% and especially between 10 and 50 wt.-% as for example between 5 and 70 wt.-%, between 5 and 50 wt.-%, between 10 and 70 wt.-% or between 10 and 60 wt.-%.

In a preferred embodiment the melting point of the first wax inhibitor is below the temperature of the formation to be fracked. In another preferred embodiment, the first wax inhibitor is present in form of a solution or dispersion of the first wax inhibitor in an organic solvent being immiscible with water. The pour point of such solution or dispersion preferably is below the temperature of the formation to be fracked. Preferably both temperatures are independently at least 10° C. and especially at least 15° C. below the temperature of the formation to be fracked. The kind and amount of organic solvent immiscible with water to be used is adjusted accordingly.

Preferred dispersions of wax inhibitors for the preparation of fracturing fluids according to the invention contain between 5 to 70 wt.-%, more preferably between 10 and 60 wt.-% and especially between 25 and 45 wt.-% as for example between 5 and 60 wt.-%, between 5 and 45 wt.-%, between 10 and 70 wt.-%, between 10 and 45 wt.-%, between 25 and 70 wt.-% or between 25 and 60 wt.-% of the solvent free wax inhibitor. Within this specification such dispersions are referred to as “concentrated dispersions”.

In a further preferred embodiment the polymerisation is carried out as an emulsion polymerisation producing a concentrated dispersion directly applicable for the purpose of the invention. Preferably the content of water, organic solvent miscible with water, organic solvent immiscible with water, wax inhibitor and dispersing agent are in the same range as for above described dispersions. The latter embodiment is especially preferred for wax inhibitors (a) and (b).

Preferred concentrated dispersions of wax inhibitors (a) to (e) contain up to 10 wt.-%, more preferably 0.1 to 8 wt.-% and especially 0.5 to 5 wt.-% as for example 0.1 to 10 wt.-% or 0.1 to 5 wt.-% or 0.5 to 10 wt.-% or 0.5 to 8 wt.-% of one or more dispersing agents selected from non-ionic, anionic, cationic and zwitterionic surfactants.

Preferred anionic surfactants contain a lipophilic radical and a polar head group which bears an anionic group, for example a carboxylate, sulfonate, phosphonate or phenoxide group. Typical anionic surfactants include, for example, fatty acid salts of fatty acids having a preferably linear, saturated or unsaturated hydrocarbon radical having 8 to 24 carbon atoms. Preferred salts are the alkali metal, alkaline earth metal, ammonium, alkylammonium and hydroxylalkyl ammonium salts, for example but not limited to sodium palmitate, potassium oleate, ammonium stearate, diethanolammonium talloate and triethanolammonium cocoate. Further suitable anionic surfactants are polymeric anionic surfactants, for example based on neutralized copolymers of alkyl (meth)acrylates and (meth)acrylic acid, and neutralized partial esters of styrene-maleic acid copolymers. Also suitable as surfactants are alkyl-, aryl- and alkylarylsulfonates, sulfates of alkoxylated fatty alcohols, alkyl phenols and sulfosuccinates, and especially the alkali metal, alkaline earth metal, ammonium, alkyl ammonium and hydroxyalkyl ammonium salts thereof.

Preferred cationic surfactants contain a lipophilic radical and a polar head group which bears a cationic group. Typical cationic surfactants are salts of long-chain primary, secondary and tertiary amines of natural or synthetic origin. Also suitable as cationic surfactants are quaternary ammonium salts, for example tetraalkylammonium salts and imidazolinium salts derived from tallow fat.

Preferred zwitterionic surfactants contain a lipophilic radical and a polar head group which bears both an anionic site and a cationic site which are joined to one another via covalent bonds. Typical zwitterionic surfactants include, for example, N-alkyl N-oxides, N-alkyl betaines and N-alkyl sulfobetaines, the alkyl residues having preferably between 10 and 20 carbon atoms.

Preferred nonionic surfactants contain a lipophilic radical and a polar, electro neutral head group. Examples for preferred nonionic surfactants are C₈- to C₂₀-alkanols, C₈- to C₁₂-alkyl phenols, C₈- to C₂₀-fatty acids and C₈- to C₂₀-fatty acid amides, optionally alkoxylated with 2 to 80 moles and preferably with 5 to 50 moles as for example with 2 to 50 moles, 5 to 20 moles or 2 to 20 moles of ethylene oxide and/or propylene oxide. Further suitable examples of nonionic surfactants are poly(alkylene oxides) in the form of block copolymers of different alkylene oxides such as ethylene oxide and propylene oxide, and partial esters of polyols or alkanolamines with fatty acids.

Preferably the weight ratio between dispersing agent (surfactant) and the wax inhibitor to be dispersed is between 1:50 and 1:1, more preferably between 1:25 and 1:2, and especially between 1:20 and 1:5, as for example between 1:50 and 1:2 or between 1:50 and 1:5 or between 1:25 and 1:1 or between 1:25 and 1:5 or between 1:20 and 1:1 or between 1:20 and 1:2. The dispersing agent may be a single surfactant or a mixture of two or more as for example 3, 4, 5 or more surfactants.

The proportion of the continuous phase comprising water and optionally a water soluble organic solvent in preferred concentrated dispersions of wax inhibitors (a) to (e) is between 30 and 95 wt.-%, more preferably between 40 and 90 wt.-% and especially between 55 and 75 wt.-%, for example between 30 and 90 wt.-%, between 30 and 75 wt.-%, between 40 and 95 wt.-%, between 40 and 75 wt.-%, between 55 and 95 wt.-% or between 55 and 90 wt.-%.

The concentrated dispersions of wax inhibitors (a) to (e) may contain minor amounts of further ingredients, for example substances for modification of the rheology of the continuous phase. Preferably the amount of such further ingredients is below 3 wt.-% and especially between 0.01 and 1 wt.-% as for example between 0.01 and 3 wt.-% of the dispersion.

Procedures for preparation of concentrated dispersions of wax inhibitors (a) to (e) suitable in the invention are known in the art. For example, the constituents of the dispersion can be combined, optionally with heating, and homogenized with heating and stirring. To improve the long-term stability of the dispersion, it has often been found to be useful to reduce the particle size of the dispersions by strong shearing. To this end, the optionally heated dispersion is exposed to high shear rates of at least 10³ s⁻¹ and preferably of at least 10⁵ s⁻¹, for example of at least 10⁶ s⁻¹, as can be obtained, for example, by means of toothed disk dispersers (e.g. Ultra-Turrax®) or high-pressure homogenizers with conventional or preferably angular channel architecture (Microfluidizer®). Suitable shear rates are also achievable by means of a Cavitron or ultrasound.

Preferably the average particle size of the concentrated dispersions of wax inhibitors (a) to (e) is less than 20 μm and more preferably between 0.001 and 10 μm, especially between 0.01 and 5 μm and most preferred below 2 μm as for example between 0.001 and 20 μm or between 0.001 and 10 μm or between 0.001 and 5 μm or between 0.001 and 2 μm or between 0.01 and 20 μm or between 0.01 and 10 μm or between 0.01 and 5 μm or between 0.01 and 2 μm. In preferred dispersions the wax inhibitor particles are distributed uniformly throughout the continuous phase.

Especially preferred concentrated dispersions of wax inhibitors (a) to (e) are those according to WO 2008/083724 comprising at least one alkanolamine salt of a polycyclic carboxylic acid as dispersing agent. Preferred salts are preparable by neutralizing at least one polycyclic carboxylic acid, the polycyclic carboxylic acid preferably containing at least three ring systems which are joined via in each case two vicinal carbon atoms of two ring systems with at least one alkanolamine. Suitable alkanolamines for preparing the salts are primary, secondary and tertiary amines which bear at least one alkyl radical substituted by a hydroxyl group. The polycyclic carboxylic acid salts can be used as such or in combination with further dispersing agents (surfactants). For instance, they are used in a preferred embodiment in combination with anionic, cationic, zwitterionic and/or nonionic surfactants.

Further preferred concentrated dispersions are those according to WO 2012/170241 comprising i) an ethylene vinyl acetate copolymer (EVA); ii) a dispersing agent, being preferably a sodium salt of a fatty acid; iii) water; and optionally iv) an aqueous freezing point depressant; optionally v) a stabilizing agent; and optionally vi) an additional additive selected from a biocide, a colorant, an anti-foaming agent, or a mixture thereof.

Further preferred concentrated dispersions are those according to WO 2016/137922 comprising (i) an ethylene vinyl acetate copolymer (EVA); (ii) a dispersing agent, being preferably a sodium or potassium salt of a fatty acid; (iii) a nonionic ethoxy-containing surfactant, preferably an alcohol ethoxylate; (iv) water; (v) a hydrocarbon solvent; and optionally (vi) an aqueous freezing point depressant; optionally (vii) a stabilizing agent in addition to and different from the polyethoxylated nonionic surfactant (iii); optionally (viii) an additional additive selected from a biocide, a colorant, an anti-foaming agent, or a mixture thereof, and optionally (ix) a basic metal substance.

For the preparation of the fracturing fluid of the invention a concentrated dispersion of the first wax inhibitor is mixed with the carrier fluid.

In a preferred embodiment the mixing occurs on-the-fly by continuously dosing the concentrated dispersion of the first wax inhibitor into the stream of carrier fluid prior to being pumped into the borehole. The addition may take place before, during or after further ingredients of the carrier fluid have been added. Subsequent in-line mixing with dynamic mixers or preferably with static mixers often has proven to be advantageous for homogenization of the dispersion in the carrier fluid. Surprisingly the wax inhibitor remains stably dispersed in the carrier fluid without separation and/or creaming of the water insoluble polymer and formation of polymeric precipitates. However, getting into contact with crude oil the carrier fluid releases the wax inhibitor into the crude oil and prevents the precipitation of waxes at the face of the fracture.

In case the carrier fluid is prepared batch-wise the mixing of the concentrated dispersion of the first wax inhibitor with carrier fluid can be accomplished by pouring the concentrated dispersion into the carrier fluid. Simple stirring is usually sufficient to ensure homogeneous distribution of the dispersion in the carrier fluid resp. in the fracturing fluid.

In both mixing processes the particle size of the dispersed first wax inhibitor in the carrier fluid remains essentially the same as for the concentrated dispersions described above.

Preferably the concentrated dispersion of the first wax inhibitor is added to the carrier fluid in amounts of 0.005 to 2 wt.-% and especially in amounts of 0.01 to 1 wt.-% as for example in amounts of 0.005 to 1 wt.-% or in amounts of 0.01 to 2 wt.-% to the carrier fluid. Preferred carrier fluids contain 0.001 to 1.5 wt.-%, more preferably 0.005 to 1.0 wt.-% as for example 0.001 to 1.0 wt.-% or 0.005 to 1.5 wt.-% of the dispersed first wax inhibitor (polymer). It should be pointed out that the concentrated dispersion of the first wax inhibitor comprises the wax inhibitor itself together with e.g. solvent. The content in active wax inhibitor does not exceed 1.5 wt.-%.

In order to cope with wax deposition in the formation during fracturing treatment as well as in the well during start-up of oil production the carrier fluid is often used to transport a water insoluble solid proppant into the formation wherein the solid proppant may comprise an immobilized second wax inhibitor.

In case the water insoluble solid proppant comprises an immobilized second wax inhibitor it may be a proppant and especially a porous proppant with the surface and/or pores being impregnated with the second wax inhibitor. Alternatively, a water insoluble solid proppant comprising an immobilized second wax inhibitor may be a mixture of a water insoluble solid porous proppant functioning as an adsorbent, the cavities of the adsorbent being filled or at least impregnated with the second wax inhibitor in admixture with a further water insoluble solid porous proppant. The further proppant and the adsorbent may be selected from the same or different materials, preferably they are different. Preferably the adsorbent has a higher surface area and/or porosity than the further proppant. Both options are often referred to as “solid wax inhibitors”.

The water insoluble solid proppants suitable in the present invention are the proppants known to those skilled in the art. Generally they comprise particles which are not limited to any particular material or size, so long as the particle has sufficient strength to withstand the stresses, such as elevated temperature and pressure, often encountered in oil and gas recovery applications. The proppant may be a sand, a naturally occurring mineral fibre, a ceramic, a bauxite, a glass, a metal bead, a walnut hull, a composite particle, and the like. Preferably the water insoluble solid proppant is selected from sand, glass beads, ceramics and crushed walnut hulls. In most cases sand is the proppant of choice, but e.g. high closure pressures require more specialized proppants like ceramic or glass beads. Often proppants are coated with a thin layer of polymer to improve the conductivity of the fracture, e.g. by improving their capability to withstand high closure stresses, to modify the hydrophilicity of their surfaces, to reduce the proppant flow back and/or to minimize the production of formation fines. The particle size of preferred proppants falls within a range from about 100 microns to about 3000 microns (about 3 mm). In another aspect, the particle size is from about 125 microns to about 2500 microns, from about 150 microns to about 2000 microns, or from about 175 microns to about 1500 microns.

The water insoluble solid adsorbent may be any of various kinds of commercially available high surface area materials having the affinity to adsorb the desired second wax inhibitor. Typically, the surface area of the adsorbent for the second wax inhibitor is between from about 1 m²/g to about 100 m²/g. Suitable adsorbents include porous ceramics, finely divided minerals, fibres, ground almond shells, ground walnut shells, and ground coconut shells. Further suitable water-insoluble adsorbents include activated carbon and/or coals, silica particulates, precipitated silicas, silica (quartz sand), alumina, silica-alumina such as silica gel, mica, silicate, e.g., orthosilicates or metasilicates, calcium silicate, sand (e.g., 20-40 mesh), bauxite, kaolin, talc, zirconia, boron and glass, including glass microspheres or beads, fly ash, zeolites, diatomaceous earth, fuller's earth and organic synthetic high molecular weight water-insoluble adsorbents. Further useful as adsorbents are clays such as natural clays, preferably those having a relatively large surface. Other examples of such high surface area materials include such clays as bentonite, illite, montmorillonite and synthetic clays. Mixtures of different adsorbents have also be used successfully. Particularly preferred are porous ceramics, diatomaceous earth and ground walnut shells.

A ceramic can include both porous and non-porous ceramic materials. Preferred porous ceramic as well as porous polymer materials can be of natural origin or can be produced synthetically. In certain cases a porous proppant can take over the function of the solid adsorbent. The wax inhibitor can be deposited in the pores of such proppant.

Preferably the water-insoluble solid adsorbent may contain up to 80 wt.-% of wax inhibitor in respect to its own weight, preferably between 1 and 50 wt.-% and especially between 5 and 30 wt.-% as for example between 1 and 80 wt.-%, between 1 and 30 wt.-%, between 5 and 80 wt.-% or between 5 and 50 wt.-%. Impregnation may be achieved by methods like cold coating, hot coating, sputtering, chemical bath deposition and the like.

In a preferred embodiment the impregnated adsorbent is coated for example with a slowly degradable and/or soluble film in order to delay the release of the adsorbed inhibitor. Suitable films may be formed by phenol formaldehyde resins (preferably different from the wax inhibitor), epoxy resins, thermoplastic materials, fatty acids and/or waxes.

Preferably the impregnated adsorbent is used in admixture with a further proppant. Preferably 0.1 to 30 wt.-%, more preferably 0.5 to 15 wt.-% and especially 1 to 10 wt.-% as for example 0.1 to 15 wt.-%, 0.1 to 10 wt.-%, 0.5 to 30 wt.-%, 0.5 to 10 wt.-%, 1 to 30 wt.-% or 1 to 15 wt.-% based on the weight of proppant pumped is added to the proppant.

The content of proppant in the fracturing fluid may vary widely and may be up to 20 wt.-%. Preferably it is between 1 and 20 wt.-%, especially between 2 and 15 wt.-% as for example between 1 and 15 wt.-% or between 2 and 20 wt.-% of the fracturing fluid.

In certain cases the addition of a viscosity modifier to the aqueous carrier fluid is advantageous in order to reduce the sedimentation speed of the water insoluble proppant. Especially 0.01 to 0.4 wt.-% of biopolymers or up to 4 wt.-% as for example 0.1 to 3 wt.-% of viscoelastic surfactants have been successfully applied.

The fracturing fluid may contain further water soluble chemicals including: friction reducer, surfactants, scale inhibitor, biocide, clay stabilizer, salt, pH-adjusting agent, iron control, corrosion inhibitor, breaker, crosslinker and other chemicals, each playing a vital role in success of a fracturing job. These may be dissolved in the aqueous phase or infused into the proppant. If applied, the preferred content of further water soluble chemicals is in the range of 0.001 to 3 wt.-% and especially 0.01 to 2 wt.-% as for example 0.001 to 2 wt.-% or 0.01 to 3 wt.-% of the fracturing fluid.

The fracturing fluids of the invention suppress wax deposition especially during the initial stages of a fracturing operation when huge amounts of carrier fluid are pumped into the formation for example as a prepad or pad fluid injection. Especially when a solid proppant comprising an immobilized second wax inhibitor is added they equally suppress wax deposition during early post-stimulation flowback. This becomes evident for example by a reduced steady shear viscosity of the so treated waxy crude, the viscoelastic behaviour of the treated crude, a reduced yield stress of the treated crude and/or reduced wax deposition using cold finger testing especially above the pour point of the crude. Thereby the fracturing fluids of the invention prevent formation of blockages in the formation and ensure a maximum conductivity and production capacity of the treated well. The fracturing fluids of the invention are easy to be prepared by dilution of the concentrated dispersion of wax inhibitor with the carrier fluid. This can be advantageously practiced by on-the-fly dosing into the carrier fluid at the location of the fracturing operation, i. e. at the well without the need for transportation of large volumes of liquid to the well. Surprisingly concentrated and stable dispersions of wax inhibitors are compatible with the carrier fluid; the wax inhibitor remains stably dispersed in the carrier fluid after addition of the concentrated dispersion to the carrier fluid without separation/creaming of the water insoluble polymer—under surface conditions as well as under reservoir conditions. However, in contact with hydrocarbon fluids of the formation they release the wax inhibitor into the oil.

Within this specification, percentages are weight percentages unless specified otherwise.

The following examples illustrate the practice of the invention:

### EXAMPLES

A. Methods and Materials Used

Weight average molecular weights (Mw) of polymers were determined by GPC in THF against poly(styrene standards). The particle sizes and distributions of dispersions were determined by means of a Mastersizer 2000 instrument from Malvern Instruments. Pour points were measured according to ISO 3016. Rheological measurements of crude oil, including viscosity and yield stress were performed on a Thermo Haake Rheostress RS6000 rheometer (Thermo Scientific, Karlsruhe, Germany) using a double gap concentric cylinder measuring geometry CC27 DG Ti or a plate-cone geometry C35/1° CSL. The instrument was equipped with TM-PC Peltier heating/cooling device allowing consistent and accurate temperature ramp profile. Cold finger tests were done using a PSL Systemtechnik (Germany) Cold Finger Model CF15120.

Dispersions of wax inhibitors were prepared by mixing a solution of the respective polymeric active in xylene or in a higher boiling aromatic solvent (Solvent Naphtha; boiling range 185-220° C.) with anionic surfactant (diethanolammonium salt of carboxylic acids), water and ethylene glycol, according to WO 2008/083724. The dispersions were sheared with an Ultra-Turrax® to further reduce the particle size. All dispersions were stable and did not show sediment for at least four weeks.

TABLE 1
Characterization of wax inhibitors used

Dispersion

| | |
|---|---|
| D1 | Dispersion of a 40 wt.-% active solution in Solvent |
| | Naphtha of an ethylene-vinyl acetate copolymer |
| | containing 25 wt.-% vinyl acetate and having a weight |
| | average molecular weight (Mw) of 95.000 g/mol. The |
| | pour point of the dispersed phase was 42° C. The active |
| | (polymer) content of the dispersion was 23 wt.-%; the |
| | average particle size was 1.6 μm. |
| D2 | Dispersion of poly(stearyl acrylate) with a K-value of |
| | 30 (measured according to Fikentscher in 5% toluene |
| | solution) 50 wt.-% active in xylene. The pour point of |
| | the dispersed phase was 18° C. The active (polymer) |
| | content of the dispersion was 29 wt.-%; the average |
| | particle size was 0.9 μm. |
| D3 | Dispersion of an ethylene-vinyl acetate copolymer which |
| | had been grafted with behenyl acrylate in a weight-ratio |
| | of 1:4 60 wt.-% active in xylene. The pour point of the |
| | dispersed phase was 24° C. The dispersion had an active |
| | (polymer) content of 33 wt.-% and an average particle |
| | size of 1.5 μm. |
| D4 | Dispersion of a copolymer of maleic anhydride and |
| | C₂₀₋₂₄-α-olefin, esterified with behenic acid 50% active |
| | in Solvent Naphtha. The pour point of the dispersed phase |
| | was 27° C. The dispersion had an active (polymer) |
| | content of 30 wt.-% and an average particle size of 1.2 |
| | μm. |
| D5 | Dispersion of a C₃₀₊-alkylphenol-formaldehyde resin (Mw |
| | 12.000 g/mol) 40 wt.-% active in Solvent Naphtha. The |
| | pour point of the dispersed phase was 9° C. The |
| | dispersion had an active (polymer) content of 25 wt.-%; |
| | the average particle size was 2.0 μm. |
| D6 (comp.) | Solution of ethylene-vinyl acetate copolymer (25 wt.-% |
| | vinyl acetate, Mw 95.000 g/mol) in aromatic solvent |
| | having an active (polymer) content of 23 wt.-%. The pour |
| | point was 42° C. |
| D7 (comp.) | Aqueous dispersion of polyethylene with weight average |
| | molecular weight of 100.000 g/mol and a degree of |
| | branching of 30 CH₃/1000 CH₂ groups. The melting |
| | temperature of the polyethylene was 103° C. The |
| | dispersion had an active (polymer) content of 50 wt.-%; |
| | the average particle size was 0.3 μm. |

B. Stability of Wax Inhibitor Dispersions in Carrier Fluid

The dispersions characterized in table 1 were added to a typical carrier fluid with stirring for 10 min. The carrier fluid contained 3% KCl in city tap water, 0.001% phosphonate scale inhibitor (diethylenetriaminepenta (methylenephosphonic) acid (DTPMP)), 0.01% nonionic surfactant (alkoxilated lauric alcohol), and 0.005% anionic polyacrylamide friction reducer. The samples were visually graded after standing at room temperature respectively at 75° C. for 2, 4 and 8 hours. The rating given in table 2 was made according to the following grading:

1=stable (homogeneously turbid, no separation)

2=not stable (waxy or oily precipitate on surface and/or glassware)

TABLE 2
Stability of the dispersion of wax inhibitor in carrier fluid

| | | content | stability at room temperature | | | stability at 75° C. | | |
|---|---|---|---|---|---|---|---|---|
| example | wax inhibitor | (wt.-%) | 2 hours | 4 hours | 8 hours | 2 hours | 4 hours | 8 hours |
| 1 | D1 | 0.05 | 1 | 1 | 1 | 1 | 1 | 1 |
| 2 | D2 | 0.10 | 1 | 1 | 1 | 1 | 1 | 1 |
| 3 | D3 | 0.05 | 1 | 1 | 1 | 1 | 1 | 1 |
| 4 | D3 | 0.50 | 1 | 1 | 1 | 1 | 1 | 1 |
| 5 | D3 | 0.10 | 1 | 1 | 1 | 1 | 1 | 1 |
| 6 | D4 | 0.25 | 1 | 1 | 1 | 1 | 1 | 1 |
| 7 | D5 | 0.10 | 1 | 1 | 1 | 1 | 1 | 1 |
| 8 | D1 + D4 | 0.1 + 0.1 | 1 | 1 | 1 | 1 | 1 | 1 |
| 9 (comp.) | D6 | 0.1 | 2 | 2 | 2 | 2 | 2 | 2 |
| 10 (comp.) | D7 | 0.1 | 1 | 1 | 1 | 1 | 1 | 1 |

C. Impact of Wax Inhibitors Dispersed in Carrier Fluids on Crude Oil Viscosity

These examples are to demonstrate the efficacy of wax inhibitors dispersed in carrier fluid on reduction of viscosity of a waxy crude oil under cooling conditions above the pour point of the oil. To mimic downhole conditions for a crude oil-carrier fluid system a sample containing equal amounts of crude oil and carrier fluid containing dispersed wax inhibitor was charged into a Teflon-line pressurized autoclave. The untreated crude oil had a pour point of −24° C., the carrier fluid used was the brine as depicted in examples 1 to 9.

The autoclave was pressurized with nitrogen gas to 1000 psi and was allowed to incubate for 24 hours under static condition (no mixing) at 75° C. in order to mimic downhole conditions. Subsequently viscosity was analysed using steady shear viscosity measurement upon a cooling program at shear rate of 10 s−1.

TABLE 3
Viscosity of crude oil after oil-brine incubation for 24 hours.

| | | Viscosity (cP) | | | | |
|---|---|---|---|---|---|---|
| example | wax inhibitor | −20° C. | −10° C. | 0° C. | 10° C. | 20° C. |
| 11 (comp.) | none | 3200 | 1017 | 229 | 24 | 13 |
| 12 | 0.01 wt.-% D1 | 390 | 148 | 61 | 22 | 12 |
| 13 | 0.02 wt.-% D1 | 378 | 136 | 58 | 22 | 11 |
| 14 | 0.02 wt.-% D2 | 403 | 145 | 56 | 23 | 11 |
| 15 | 0.01 wt.-% D3 | 360 | 130 | 54 | 23 | 12 |
| 16 | 0.02 wt.-% D3 | 368 | 138 | 53 | 22 | 12 |
| 17 | 0.03 wt.-% D3 | 364 | 135 | 55 | 23 | 12 |
| 18 | 0.04 wt.-% D3 | 371 | 140 | 53 | 23 | 12 |
| 19 | 0.05 wt.-% D3 | 382 | 137 | 55 | 23 | 12 |
| 20 | 0.02 wt.-% D4 | 379 | 142 | 56 | 22 | 11 |
| 21 | 0.10 wt.-% D4 | 358 | 131 | 51 | 21 | 10 |
| 22 | 0.05 wt.-% D5 | 410 | 154 | 64 | 22 | 12 |
| 23 (comp.) | 0.10 wt.-% D7 | 2800 | 905 | 204 | 24 | 13 |

Examples 10 to 21 show that the addition of even 0.01 wt.-% of dispersed wax inhibitor to the aqueous carrier phase significantly reduces the viscosity of crude oil above its pour point. On the contrary, the addition of polyethylene (D7) does not give a comparable result. Supposedly the dissolution rate is too slow.

D. Impact of Wax Inhibitors Dispersed in Carrier Fluid on Crude Yield Stress

These examples are designed to show the effect of a wax inhibitor dispersed in aqueous carrier fluid on the yield stress of crude oil under downhole conditions. In analogy to the experimental setup of examples 10 to 21 a sample of crude oil with a pour point of −12° C. (untreated) was incubated with an equal amount of carrier fluid containing dispersed wax inhibitor at 1000 psi pressure of nitrogen gas for 24 hours under static condition (no mixing) at 75° C. Subsequently the crude was analysed for yield stress. Yield stress measurements were done using a shear stress ramp of 5 Pa/min from 0.1 to 50 Pa when sample was cooled at constant cooling rate of 1° C./min and incubated at −10° C. for 10 minutes.

TABLE 4
Crude oil yield stress data after oil
and brine incubated for 24 hours.

| example | Wax inhibitor | Yield Stress (Pa) |
|---|---|---|
| 24 (comp.) | 0 | >50 |
| 25 | 0.02 wt.-% D1 | 4.3 |
| 26 | 0.02 wt.-% D2 | 2.9 |
| 27 | 0.01 wt.-% D3 | 2.3 |
| 28 | 0.02 wt.-% D3 | 1.4 |
| 29 | 0.03 wt.-% D3 | 1.4 |
| 30 | 0.04 wt.-% D3 | 1.3 |
| 31 | 0.05 wt.-% D3 | 1.2 |
| 32 | 0.01 wt.-% D4 | 2.5 |
| 33 | 0.05 wt.-% D4 | 1.5 |
| 34 | 0.02 wt.-% D3 + 0.02 wt.-% D4 | 1.1 |
| 35 | 0.02 wt.-% D5 | 1.8 |
| 36 | 0.10 wt.-% D5 | 1.3 |
| 37 (comp.) | 0.02 wt.-% D7 | 44 |
| 38 (comp.) | 0.10 wt.-% D7 | 31 |

Examples 22-34 show the efficacy of a wax inhibitor dispersed in the carrier fluid on reducing the yield stress of a waxy crude under an extreme cooling condition but still far above the pour point of the crude. It was found that addition of even 0.01 wt.-% of wax inhibitor according to the invention dispersed in the carrier fluid significantly reduces the yield stress of crude from more than 50 Pa to only 2.3 Pa.

E. Impact of Wax Inhibitors Dispersed in Carrier Fluid on Wax Deposition from Crude Oil

These examples are designed to show the effect of a wax inhibitor dispersed in aqueous carrier fluid on the wax deposition from crude oil under downhole conditions using the industry widely practiced cold finger test method. In analogy to the experimental setup of examples 10 to 21 a sample of crude oil with a pour point of −6° C. (untreated) was incubated with an equal amount of carrier fluid containing dispersed wax inhibitor at 1000 psi pressure of nitrogen gas for 24 hours under static condition (no mixing) at 50° C. to mimic downhole conditions. 80 mL of the oil phase was then transferred to the Cold Finger Testing apparatus for wax deposition testing. The crude sample was kept at 50° C., while the cold finger was set at 20° C. Testing was conducted for a duration of 4 hours and subsequently the amount of wax collected on the cold finger was measured by weight. Inhibition efficacy was calculated by net reduction of mass of wax collected from treated crude sample compared to the untreated one. Experiments were done in triplicate and an average is reported. The results are summarized in Table 5.

TABLE 5
Wax deposition and inhibition using cold finger method

| example | wax inhibitor (wt.-% of carrier fluid) | Inhibition (%) |
|---|---|---|
| 39 (comp.) | 0 | 0 |
| 40 | 0.030 wt.-% D1 | 14 |
| 41 | 0.020 wt.-% D2 | 10 |
| 42 | 0.060 wt.-% D2 | 52 |
| 43 | 0.080 wt.-% D2 | 58 |
| 44 | 0.030 wt.-% D3 | 18 |
| 45 | 0.060 wt.-% D3 | 62 |
| 46 | 0.025 wt.-% D4 | 9 |
| 47 | 0.050 wt.-% D4 | 42 |
| 48 | 0.075 wt.-% D4 | 65 |
| 49 | 0.100 wt.-% D4 | 71 |
| 50 | 0.025 wt.-% D1 + 0.025 wt.-% D2 | 64 |
| 51 | 0.050 wt.-% D5 | 38 |
| 52 (comp.) | 0.050 wt.-% D7 | 2 |
| 53 (comp.) | 0.200 wt.-% | 12 |

F. Impact of Wax Inhibitors Dispersed in Carrier Fluid on Wax Deposition from Model Oil

To mimic wax deposition upon cooling of the formation by injecting fracturing fluid under downhole conditions a model crude was prepared. 1.0 wt.-% of high molecular weight paraffins with a carbon chain distribution from C₃₅-C₆₅ (often known in industry as problematic ones) were dissolved in kerosene. The pour point of this model oil was −42° C. In analogy to the experimental setup of examples 10 to 21 a sample of this model crude was incubated with an equal amount of carrier fluid containing 0.1 wt.-% of wax inhibitor dispersion was kept at 1000 psi pressure of nitrogen gas for 24 hours under static condition (no mixing) at 75° C.

80 mL of the oil phase was then transferred to a Cold Finger Testing apparatus for wax deposition testing. The crude sample was kept at 50° C., while the cold finger was set at 40° C. The testing was conducted for duration of 8 hours and subsequently the amount of wax collected on the cold finger was measured by weight. Inhibition efficacy was calculated by net reduction of mass of wax deposit collected from treated crude sample compared to the untreated one. Experiments were done in duplicates and an average was reported. Results are summarized in Table 6.

TABLE 6
Wax deposition and inhibition using cold finger method.

| example | Wax inhibitor | Inhibition % |
|---|---|---|
| 54 (comp.) | none | 0 |
| 55 | D1 | 15 |
| 56 | D2 | 31 |
| 57 | D3 | 37 |
| 58 | D4 | 49 |
| 59 | D5 | 39 |
| 60 | Mixture of D1, D3 and D4 | 59 |
| | (at 1:1:1 wt.-ratio) | |
| 61 | Mixture of D2, D3 and D4 | 62 |
| | (at 1:1:1 wt.-ratio) | |
| 62 | Mixture of D3 and D4 | 65 |
| | (at 1:1 wt.-ratio) | |
| 63 | Mixture of D3, D4 and D5 | 61 |
| | (at 1:1:1 wt.-ratio) | |

The examples given in tables 5 and 6 show the efficacy of wax inhibitors dispersed in the carrier fluid on inhibition of paraffin wax deposition on surfaces. In the examples the neat crude oils selected have pour points well below the finger temperature, so they can still flow under the experimental conditions. However, at the fingers deposition of wax occurs and is reduced by addition of wax inhibitor dispersion to the carrier fluid, the reduction ranging from 15% to 65%. It was also found that a combination of inhibitors provides higher inhibition when compared to single products.

G. Impact of Wax Inhibitors Dispersed in Carrier Fluid on Fracturing Fluid Gel Stability

Stability of a borate cross-linked guar slurry fracturing fluid upon addition of wax inhibitor dispersions D1 and D3 was evaluated by measuring the viscosity of the gelled carrier fluid at elevated temperature. The carrier fluid was prepared from 0.4 wt.-% guar in 3 wt.-% KCl solution, added with wax inhibitor dispersion D1 respectively D3 and crosslinked using a borate additive. A Brookfield rotational viscometer model PVS was used to measure the viscosity of the fluid at a constant shear rate of 100 s⁻¹ and a pressure of 1000 psi. The fluid was heated to 80° C. within a period of 15 min and maintained at that temperature for 45 min. Viscosity data for the gelled fluids are given in Table 7.

TABLE 7
Viscosity of carrier fluid in the presence
of wax inhibitor dispersion

| | | Viscosity (cP) | | | |
|---|---|---|---|---|---|
| | Test | carrier | carrier | carrier | |
| | Time | fluid | fluid + | fluid + | Temp |
| example | (min) | (comp.) | 0.1 wt.-% D1 | 0.1 wt.-% D3 | (° C.) |
| 64 | 1 | 1840 | 1689 | 1603 | 30 |
| 65 | 5 | 1113 | 1254 | 1158 | 54 |
| 66 | 10 | 719 | 801 | 726 | 76 |
| 67 | 20 | 490 | 623 | 579 | 80 |
| 68 | 30 | 531 | 596 | 582 | 80 |
| 69 | 40 | 541 | 651 | 640 | 80 |
| 70 | 50 | 527 | 627 | 579 | 80 |
| 71 | 60 | 520 | 623 | 637 | 80 |

The viscosity of fracturing fluids has direct impact on carrying proppant loading and keeping proppant suspended during fracturing job and after fracture pressure is lifted. Linear or cross-linked gels are typically used to increase viscosity of hydraulic fracturing fluids. As found from above experiments, wax inhibitor dispersions have no negative impact on fluid viscosity at temperatures from 30 to 80° C.

H. Impact of Wax Inhibitors Dispersed in Fracturing Fluid Comprising Proppant impregnated with second wax inhibitor on crude viscosity

To show the synergism between the carrier fluid containing the dispersion of a first wax inhibitor and a solid second wax inhibitor the effect of the single components was compared with their combination.

In analogy to the experimental setup of examples 10 to 21 a crude oil with pour point of 30° C. (neat) was incubated with an equal amount of carrier fluid containing 0.1 wt.-% of a mixture of wax inhibitor dispersions D3 and D4 at 1:1 wt.-ratio (D3/D4) at 1000 psi pressure of nitrogen gas for 24 hours under static condition (no mixing) at 75° C. (example 73).

In a second test (example 74, comparative), a further sample of the same crude oil was stored in contact with the carrier fluid in the Teflon-line pressurized autoclave. Here a proppant impregnated with wax inhibitor (solid wax inhibitor) comprising a porous ceramic impregnated with polymeric wax inhibitor, having a specific gravity of 2.3 was added at 1.0 wt.-% to the system, but no wax inhibitor dispersion was added. Due to its high specific gravity the solid wax inhibitor resides in the aqueous carrier fluid.

In a third test (example 75) similar to the second, additionally wax inhibitor dispersion was added at 0.1 wt.-% to the system already comprising the solid inhibitor.

In a fourth test (example 76, comparative), crude oil was stored in contact with solid wax inhibitor but no carrier fluid was included.

In a further set of comparative tests in analogy to examples 73 and 75 the mixture of wax inhibitor dispersions D3 and D4 was substituted by 0.1 wt.-% of dispersion D7.

The crudes were collected after 24 hours and analysed using steady shear viscosity measurement upon a cooling program at shear rate of 10 s⁻¹. Results are summarized in Table 8.

TABLE 8
Crude oil viscosity data after incubation for 24 hours.

| | | Viscosity (cP) | | | | |
|---|---|---|---|---|---|---|
| example | experiment | 20° C. | 30° C. | 40° C. | 50° C. | 60° C. |
| 72 (comp.) | untreated crude oil | 2580 | 556 | 72.4 | 15.6 | 6.3 |
| 73 | crude + CF + WID (D3/D4) | 763 | 48.6 | 15.8 | 8.2 | 6.1 |
| 74 (comp.) | crude + CF + SPI | 2326 | 550 | 71.0 | 16.2 | 6.2 |
| 75 | crude + CF + WID + SPI | 689 | 42.4 | 14.2 | 7.9 | 5.3 |
| 76 (comp.) | crude + SPI | 942 | 51.3 | 18.4 | 8.5 | 5.6 |
| 77 (comp.) | crude + CF + WID (D7) | 2187 | 516 | 64.3 | 14.8 | 6.1 |
| 78 (comp.) | crude + CF + WID (D7) + SPI | 1956 | 472 | 60.1 | 14.1 | 6.0 |

* WID = wax inhibitor dispersion, consisting of 0.1 wt.-% of a mixture of equal amounts of D3 and D4; CF = carrier fluid; SPI = solid wax inhibitor;

Results of examples 74 and 76 clearly demonstrate that once solid paraffin inhibitor is in direct contact with crude, active component is released from the substrate and reduces the viscosity of the crude oil. However, as demonstrated in comparative example 74, the solid wax inhibitor does not have any effect on crude viscosity when it resides in the carrier fluid; no inhibitor is partitioned to the oil phase and thus no impact on rheology is observed. On the other hand, in examples 73 and 75 when a dispersion of wax inhibitor is used with or without solid wax inhibitor, an immediate effect occurs as pronounced in net viscosity reduction upon cooling at steady shear rate. This clearly indicates benefits of utilization of wax inhibitor dispersion in the carrier fluid to manage wax formation and deposition in early stages of fracturing operations.

1. A fracturing fluid comprising
i) 85 wt.-% or more of an aqueous carrier fluid as continuous phase,
ii) 0.001 to 1.5 wt.-% of a first wax inhibitor being dispersed in the carrier fluid, the wax inhibitor being selected from the group consisting of
a) copolymers of ethylene and ethylenically unsaturated esters, ethers and/or C₃ to C₃₀-alkenes, which contain 4 to 18 mol-% of at least one vinyl ester, acrylic ester, methacrylic ester, alkyl vinyl ether and/or alkene,
b) homo- or copolymers of ethylenically unsaturated carboxylic acids, bearing C₁₂-C₅₀-alkyl radicals bound via ester, amide and/or imide groups,
c) ethylene copolymers grafted with ethylenically unsaturated esters and/or ethers,
d) homo- and copolymers of C₃ to C₃₀-olefins, and
e) condensation products of alkyl phenols with aldehydes and/or ketones
iv) optionally a water soluble polymer for viscosity adjustment, wherein the amount of water-immiscible hydrocarbons is less than 2.5 wt.-%.

2. The fracturing fluid as claimed in claim 1, further comprising iii) a water insoluble solid proppant.

3. The fracturing fluid as claimed in claim 2, wherein the water insoluble proppant comprises an immobilized second wax inhibitor.

4. The fracturing fluid as claimed in claim 1, in which the first and/or second wax inhibitor comprises a copolymer of ethylene and at least one ethylenically unsaturated ester, ethylenically unsaturated ether or an alkene.

5. The fracturing fluid as claimed in claim 4, in which the ethylenically unsaturated ester is a vinyl ester.

6. The fracturing fluid as claimed in claim 1, in which the first and/or second wax inhibitor comprises a homo- or copolymer of at least one ester of at least one ethylenically unsaturated carboxylic acid, said ester bearing C₁₂-C₅₀-alkyl radicals.

7. The fracturing fluid as claimed in claim 6, in which the ethylenically unsaturated carboxylic acid is acrylic acid and/or methacrylic acid.

8. The fracturing fluid as claimed in claim 1, in which the first and/or second wax inhibitor comprises an ethylene copolymer, the ethylene copolymer having side chains being introduced by a grafting reaction of an ethylenically unsaturated ester and/or ether on said copolymer.

9. The fracturing fluid as claimed in claim 6, wherein the ethylenically unsaturated ester independently is an ester of acrylic acid and/or methacrylic acid, said ester bearing C₁₂-C₅₀-alkyl radicals.

10. The fracturing fluid as claimed in claim 1, in which the first and/or second wax inhibitor comprises a homo- or copolymer of an ethylenically unsaturated dicarboxylic acid, bearing C₁₂-C₅₀-alkyl radicals bound via ester, amide and/or imide groups.

11. The fracturing fluid as claimed in claim 1, in which the first and/or second wax inhibitor comprises a homo- and copolymer of α-olefins having 3 to 30 carbon atoms.

12. The fracturing fluid as claimed in claim 1, in which the first and/or second wax inhibitor comprises a condensation product of at least one alkyl substituted phenol and at least one aldehyde or ketone.

13. The fracturing fluid as claimed in claim 3, in which the first wax inhibitor and second wax inhibitor are the same.

14. The fracturing fluid as claimed in claim 3, in which the first wax inhibitor and second wax inhibitor differ in at least one of chemical composition, molecular weight or alkyl chain length.

15. The fracturing fluid as claimed in claim 1, in which the concentration of the first wax inhibitor in the carrier fluid is between 0.005 and 1 wt.-%.

16. The fracturing fluid as claimed in claim 1, in which the first wax inhibitor is present in the carrier fluid in form of a solution or dispersion of the first wax inhibitor in an organic solvent immiscible with water.

17. The fracturing fluid as claimed in claim 16, in which the pour point of the solution or dispersion of the first wax inhibitor in an organic solvent immiscible with water is below the temperature of the formation to be fracked.

18. The fracturing fluid as claimed in claim 1, in which the melting point of the first wax inhibitor is below the temperature of the formation to be fracked.

19. The fracturing fluid as claimed in claim 1, in which the particle size of the dispersed first wax inhibitor is less than 20 μm.

20. The fracturing fluid as claimed in claim 3, wherein the water insoluble solid proppant comprising an immobilized second wax inhibitor is a mixture of
(i) a water insoluble solid porous proppant functioning as an adsorbent, the cavities of the adsorbent being filled or at least impregnated with the second wax inhibitor, with
(ii) a further proppant, the further proppant being different from the adsorbent.

21. The fracturing fluid as claimed in claim 3, wherein the water insoluble solid proppant comprising an immobilized wax inhibitor comprises a proppant selected from the group consisting of sand, ceramics, glass beads, metal beads, bauxite, naturally occurring mineral fiber, crushed walnut hulls and composite particles, coated with a wax inhibitor.

22. The fracturing fluid as claimed in claim 3, wherein the water insoluble solid proppant comprising an immobilized wax inhibitor comprises an adsorbent selected from the group consisting of porous ceramics, finely divided minerals, fibres, ground almond shells, ground walnut shells, ground coconut shells, activated carbon and/or coals, silica particulates, precipitated silica, quartz sand, alumina, silica-alumina, silica gel, mica, silicate, sand, bauxite, kaolin, talc, zirconia, boron, glass microspheres, glass beads, fly ash, zeolites, diatomaceous earth, fuller's earth and organic synthetic high molecular weight water-insoluble adsorbents, clays, bentonite, illite, montmorillonite and synthetic clays and their mixtures, coated and/or impregnated with a wax inhibitor

23. The fracturing fluid as claimed in claim 2, wherein the amount of proppant is between 1 and 20 wt.-% of the fracturing fluid.

24. The fracturing fluid as claimed in claim 1, wherein said fluid comprises, as a further component, 0.001 to 3 wt.-% of a water soluble chemical selected from the group consisting of friction reducer, surfactants, scale inhibitor, biocide, clay stabilizer, salt, pH-adjusting agent, iron control agent, corrosion inhibitor, breaker, and crosslinker.

25. A process for preparing fracturing fluids according to claim 1, wherein the concentration of the dispersed first wax inhibitor is between 0.001 and 1.5 wt.-% of the carrier fluid, by homogenizing constituents i), and optionally iii), iv) and/or v) and then admixing them with a concentrated dispersion having a content of 5 to 70 wt.-% of the first wax inhibitor ii) at a temperature between 10° C. and 60° C.

26. The process as claimed in claim 25 wherein the amount of the dispersion of the first wax inhibitor is between 0.005 and 2 wt.-% of the fracturing fluid.

27. A process for inhibiting wax precipitation during fracturing of a subterranean formation comprising injecting into the well bore a fracturing fluid according to claim 1.

28. (canceled)
